(19) United States
(12) Patent Application Publication
(10) Pub. No.: US 2010/0138540 A1
(43) Pub. Date: Jun. 3, 2010

(54) Method of managing organization of a computer system, computer system, and program for managing organization

(75) Inventors: Kazuho Tanaka, Fujisawa (JP); Tsunehiko Baba, Hachioji (JP); Takahiro Yokoyama, Yokohama (JP); Hiroyuki Osaki, Yokohama (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi, Ltd.

(21) Appl. No.: 12/457,578

(22) Filed: Jun. 16, 2009

(30) Foreign Application Priority Data
Dec. 2, 2008 (JP) 2008-307203

(51) Int. Cl. G06F 15/173

(52) U.S. Cl. 709/226; 709/242

(57) ABSTRACT

There is provided a method of managing an organization of a computer system including a plurality of servers each capable of executing requested services, the services belonging to a service group defined based on data necessary for executing the services. Service groups are assigned to the plurality of servers. The method including: selecting, when a load imposed on a server exceeds a predetermined upper limit, a server of transfer destination for executing some of the services to be executed on the server having the load exceeding the upper limit; selecting at least one service group out of service groups assigned to the server having the load exceeding the upper limit; assigning the selected service group to the server of transfer destination; and transferring data necessary for executing services belonging to the selected service group from the server having the load exceeding the upper limit to the server of transfer destination.

### CLAIM OF PRIORITY

The present application claims priority from Japanese patent application JP 2008-307203 filed on Dec. 2, 2008, the content of which is hereby incorporated by reference into this application.

### BACKGROUND OF THE INVENTION

This invention relates to a technology for managing an organization of a computer system including a plurality of computers.

In a server system which executes application processing such as payment settlement in response to a request from a client, real time property is important. The real time property means executing application processing and returning a response in a short period of time in the server system.

In order to realize the real time property, in addition to an increase in processing performance of a computer, a processing method for increasing processing efficiency by means of load distribution and the like is necessary. Specifically, a cluster is constructed by a plurality of servers, and requests from clients are processed in parallel by the plurality of servers sharing the load of the processing, thereby decreasing the processing load imposed on the respective servers, and increasing the amount of requests which can be processed.

Moreover, in a case where requests from clients are concentrated within a short period of time, in order to realize the real time property, processing such as dynamically changing the assignment of servers which process the requests according to variation in load imposed on the servers is necessary.

However, requests from clients may include a request for access to data held by individual servers. In a case where the assignment of a server which processes a request is reorganized, management of data held by the server and management of relationships between a client and the server are complex, and thus, it is difficult for an ordinary client and servers to realize the reorganization.

To address this problem, JP 2000-187632 A discloses a technology in which respective servers constituting a cluster receive a packet transmitted to a logical network address assigned to the entire cluster, and, based on parameters of the received packet, whether the packet is valid or invalid is selected. With the technology disclosed in JP 2000-187632 A, without necessity of modification of clients and setting of a name server, it is possible to change a server which actually receives a packet addressed to the logical network.

Moreover, JP 2001-216282 A discloses a technology in which, in a case where a client transmits a request for a service to a server, a physical address request is transmitted to a virtual network address assigned to a cluster. In the technology disclosed in JP 2001-216282 A, a server determines priorities of servers according to information on loads imposed on the respective servers, and, based on the determined priorities, determines whether to respond to the physical address request. A client, upon reception of a physical address, transmits a service request to the received physical address. As a result, without the necessity for setting a name server, it is possible to change a server which provides a service.

### SUMMARY OF THE INVENTION

In the technology disclosed in JP 2001-187632 A, a server which receives a packet selects, based on parameters representing a status of the server, a logical network address, and an address of a client which is the transmission source, whether or not to discard the packet. However, in a case where processing of accessing data held by individual servers is requested and a server which is to receive packets is changed, a server of the destination of the change does not hold data necessary for the processing, and hence the server cannot process the request.

Moreover, in the technology disclosed in JP 2001-216282 A, a server for processing a service request is changed according to the priorities determined based on the processing loads imposed on the respective servers. On this occasion, it is assumed that a server holds data in a large quantity, and carries out a plurality of services requiring access thereto. In this case, in order to distribute the load by carrying out reorganization so that some of the services is to be processed by another server, data necessary for processing the some of the services needs be stored in the other server selected as a result of the reorganization. However, the technology disclosed in JP 2001-216282 A does not hold information used for specifying data necessary for processing a request, and thus, it is necessary for the server selected as the result of the reorganization to hold all data. However, in a case where all the data is copied to the server selected as the result of the reorganization, a processing period and a processing load necessary for copying the data are enormous, a performance of processing requests received from clients during the data copy decreases, and hence it is hard to maintain the real time property.

The representative aspects of this invention are as follows. That is, there is provided a method of managing an organization of a computer system comprising a plurality of servers each capable of executing requested services, the plurality of servers each comprising: an interface for coupling with another one of the plurality of servers; a processor coupled to the interface; and a memory device for storing data necessary for providing the requested services, the each of plurality of servers being assigned services that refer to the same data, the method including the steps of: selecting, by one of the plurality of servers, in a case where a load imposed on the one of the plurality of servers exceeds a predetermined upper limit, a server of transfer destination for executing some of the services to be executed on the one of the plurality of servers having the load imposed thereon exceeding the predetermined upper limit; selecting, by the one of the plurality of servers, at least one service from the services assigned to the one of the plurality of servers having the load imposed thereon exceeding the predetermined upper limit; assigning, by the one of the plurality of servers, the selected at least one service to the server of transfer destination; and transferring, by the one of the plurality of servers, data necessary for executing the selected at least one service from the one of the plurality of servers having the load imposed thereon exceeding the predetermined upper limit to the server of transfer destination.

According to one embodiment of this invention, it is possible to distribute a load while the real time property is maintained.

### BRIEF DESCRIPTION OF THE DRAWINGS

The present invention can be appreciated by the description which follows in conjunction with the following figures, wherein:

FIG. 1 is a block diagram illustrating an example of a configuration of a computer system according to a first embodiment of this invention;

FIG. 2 is a block diagram illustrating a hardware configuration of the server 110 according to the first embodiment of this invention;

FIG. 3 is an explanatory diagram illustrating an overview of steps of reorganizing the computer system according to the first embodiment of this invention;

FIG. 4 is an explanatory diagram illustrating an example of a processing request message according to the first embodiment of this invention;

FIG. 5 is an explanatory diagram illustrating an example of a configuration of a processing request queue according to the first embodiment of this invention;

FIG. 6 is an explanatory diagram illustrating an example of a configuration of processing result information according to the first embodiment of this invention;

FIG. 7 is an explanatory diagram illustrating an example of a processing serial number according to the first embodiment of this invention;

FIG. 8 is an explanatory diagram illustrating an example of a configuration of the cluster information table according to the first embodiment of this invention;

FIG. 9 is an explanatory diagram illustrating an example of a configuration of a service group information table according to the first embodiment of this invention;

FIG. 10 is an explanatory diagram illustrating an example of a configuration of a service information table according to the first embodiment of this invention;

FIG. 11 is an explanatory diagram illustrating an example of a processing service group ID according to the first embodiment of this invention;

FIG. 12 is an explanatory diagram illustrating an example of a configuration of an added server response request message according to the first embodiment of this invention;

FIG. 13 is an explanatory diagram illustrating an example of a configuration of a load quantity threshold table according to the first embodiment of this invention;

FIGS. 14A and 14B are sequence diagrams illustrating steps of processing carried out on servers in response to processing requests transmitted from a client according to the first embodiment of this invention;

FIGS. 15A and 15B are sequence diagrams illustrating steps of adding the server in the status of “ACTIVE SYSTEM” to a cluster (scale-out) according to the first embodiment of this invention;

FIG. 16 is a sequence diagram illustrating steps of the service reorganization processing according to the first embodiment of this invention;

FIGS. 17A and 17B are sequence diagrams illustrating the steps of transferring the processing data to the server in the status of “ADDED SYSTEM” according to the first embodiment of this invention;

FIG. 18 is a flowchart illustrating steps of reflecting processing result information to processing data according to the first embodiment of this invention;

FIG. 19 is a flowchart illustrating steps of receiving a processing request message according to the first embodiment of this invention;

FIG. 20 is a flowchart illustrating steps of creating the service group information table according to the first embodiment of this invention;

FIG. 21 illustrates contents of the cluster information table for the existing systems after the scale-out according to the first embodiment of this invention;

FIG. 22 is an explanatory diagram illustrating contents of the cluster information table for the added systems after the scale-out according to the first embodiment of this invention;

FIG. 23 is an explanatory diagram illustrating contents of the service information table for the existing systems after the scale-out according to the first embodiment of this invention;

FIG. 24 is an explanatory diagram illustrating contents of the service information table for the added systems after the scale-out according to the first embodiment of this invention;

FIG. 25 is an explanatory diagram illustrating contents of the service group information table for the existing systems after the scale-out according to the first embodiment of this invention;

FIG. 26 is an explanatory diagram illustrating contents of the service group information table for the added systems after the scale-out according to the first embodiment of this invention;

FIG. 27 is an explanatory diagram illustrating contents of the processing service group ID for the existing systems after the scale-out according to the first embodiment of this invention;

FIG. 28 is an explanatory diagram illustrating contents of the processing service group ID for the added systems after the scale-out according to the first embodiment of this invention;

FIGS. 29A and 29B are sequence diagrams illustrating steps of preparation processing for the scale-in according to the second embodiment of this invention;

FIG. 30 is an explanatory diagram illustrating contents of the cluster information table of the server which is to be merged according to the second embodiment of this invention;

FIG. 31 is an explanatory diagram illustrating contents of the cluster information table of the server which is a destination of the merge according to the second embodiment of this invention;

FIG. 32 is an explanatory diagram illustrating contents of the cluster information table of the server which is to be merged according to the second embodiment of this invention;

FIG. 33 is an explanatory diagram illustrating an example of a configuration of the service group information table according to the third embodiment of this invention; and

FIG. 34 is an explanatory diagram illustrating an example of a configuration of the service information table according to the third embodiment of this invention.

### DETAILED DESCRIPTION OF THE PREFERRED EMBODIMENTS

A description is now given of embodiments of this invention with reference to drawings.

### First Embodiment

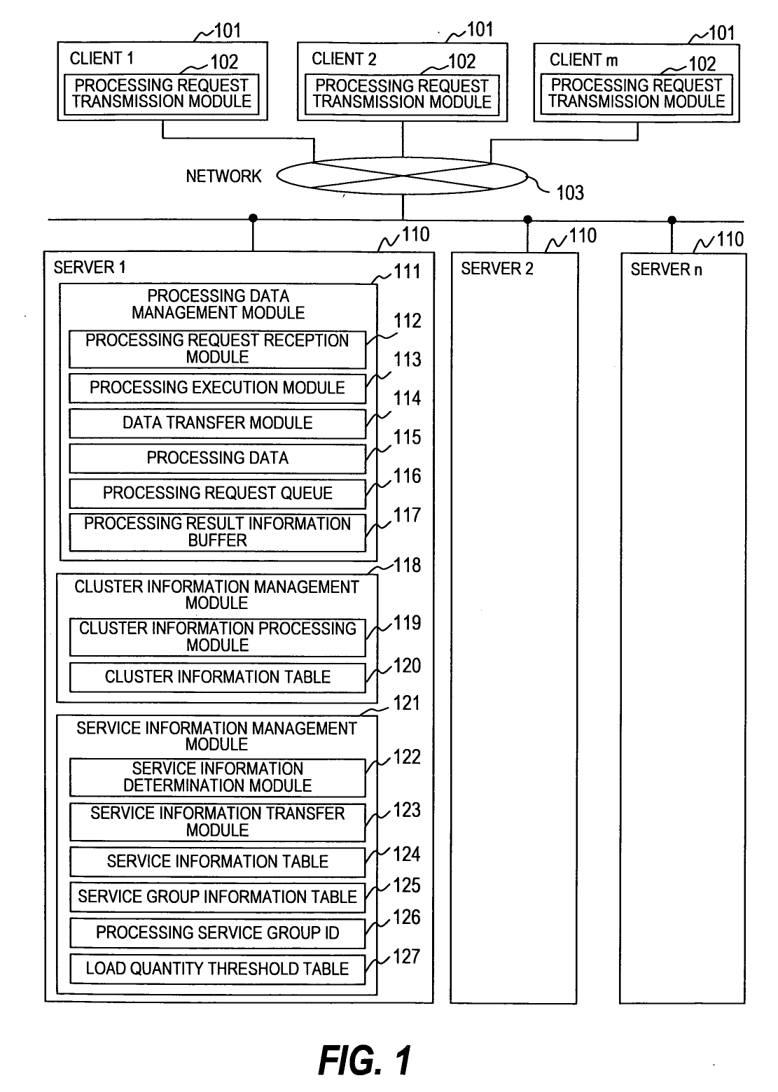

FIG. 1 is a block diagram illustrating an example of a configuration of a computer system according to a first embodiment of this invention.

The computer system according to the first embodiment of this invention includes at least one client 101 and at least one server 110. FIG. 1 illustrates an example of a configuration including m clients 101 and n servers 110 where m and n denote numbers equal to or more than one.

The client 101 and the server 110 are computers which can communicate with each other. The server 110 carries out processing requested by the client 101.

Each client 101 includes a processing request transmission module 102. The processing request transmission module 102 transmits a processing request message input by a user to the server 110. The processing request transmission module 102 is realized as a program executed on the client 101, or a dedicated hardware device for providing the same functions.

The clients 101 and the servers 110 are coupled with each other via a network 103. The network 103 carries out multicast communication which is a transmission by a client 101 directed to a plurality of servers 110, and transmits/receives data to/from the plurality of servers 110.

The servers 110 include servers in a status of “ACTIVE SYSTEM” and servers in a status of “STANDBY SYSTEM”. Moreover, the server 110 in the status of “ACTIVE SYSTEM” and the server 110 in the status of “STANDBY SYSTEM” have the same configuration. A server 110 in the status of “ACTIVE SYSTEM” executes processing requested by a client 101. A server 110 in the status of “STANDBY SYSTEM”, when a server 110 in the status of “ACTIVE SYSTEM” fails, takes over requested processing from the server 110 in the status of “ACTIVE SYSTEM”.

Each server 110 includes a processing data management module 111, a cluster information management module 118, and a service information management module 121. The processing data management module 111, the cluster information management module 118, and the service information management module 121 are respectively realized as programs executed on the server 110, or dedicated hardware devices for providing the same functions.

The processing data management module 111 includes a processing request reception module 112, a processing execution module 113, a data transfer module 114, processing data 115, a processing request queue 116, and a processing result information buffer 117.

The processing request reception module 112 receives a processing request message transmitted from a client 101, and transmits the processing request message to the processing execution module 113.

The processing execution module 113, based on the processing request message transmitted from the processing request reception module 112, carries out requested processing.

The data transfer module 114 transfers processing data 115 and processing result information stored in the processing result information buffer 117 to another server 110.

The processing data 115 includes data necessary for processing executed by the processing execution module 113. Moreover, the processing data 115 is stored in a volatile storage medium (memory) for high-speed access.

The processing request queue 116 stores information included in processing request messages transmitted by clients 101.

The processing result information buffer 117 temporarily stores results of processing carried out by the processing execution module 113.

The cluster information management module 118 includes a cluster information processing module 119 and a cluster information table 120.

The cluster information processing module 119 updates the cluster information table 120, and transmits/receives information stored in the cluster information table 120. Moreover, the cluster information processing module 119, by transmitting/receiving a processing data transfer request to/from another server 110, copies data between servers 110. Further, the cluster information processing module 119 transmits/receives an added server response request message and a response to the added server response request message.

The cluster information table 120 holds a multicast address to which the servers 110 belong, addresses of the respective servers 110, and statuses of the respective servers 110.

The service information management module 121 includes a service information determination module 122, a service information transfer module 123, a service information table 124, a service group information table 125, a processing service group ID 126, and a load quantity threshold table 127.

The service information determination module 122 detects an increase/decrease in load imposed on the server 110.

The service information transfer module 123 updates the service information table 124, the service group information table 125, and the processing service group ID 126, and transmits/receives information to another server 110.

The service information table 124 stores identifiers of respective services, identifiers of tables storing data used for the respective services, and load quantities of the respective services. The service group information table 125 stores identifiers of respective service groups, identifiers of services belonging to the respective service groups, and sums of load quantities of the services belonging to the respective service groups.

The processing service group ID 126 is an identifier for identifying a service group processed by the respective servers 110. The load quantity threshold table 127 stores thresholds of load quantities serving as references for reorganizing a service group.

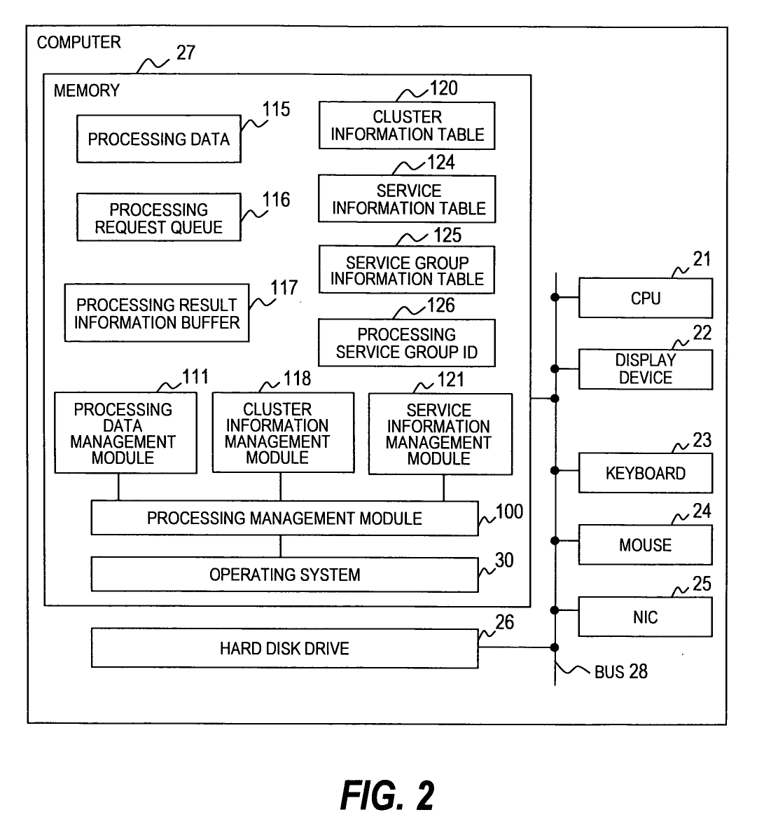

FIG. 2 is a block diagram illustrating a hardware configuration of the server 110 according to the first embodiment of this invention.

As described above, the server 110, regardless of whether the server 110 is in the status of “ACTIVE SYSTEM” or in the status of “STANDBY SYSTEM”, has the same configuration. Each server 110 includes a CPU 21, a display device 22, a keyboard 23, a mouse 24, a network interface card (NIC) 25, a hard disk drive 26, and a memory 27. The CPU 21, the display device 22, the keyboard 23, the mouse 24, the NIC 25, the hard disk drive 26, and the memory 27 are coupled with each other via a bus 28.

The respective servers 110 in the statuses of “ACTIVE SYSTEM” and “STANDBY SYSTEM” couple via the NIC 25 to the network 103, and communicate with other servers 110.

The CPU 21 executes a program stored in the memory 27. The memory 27 temporarily stores the programs executed by the CPU 21, and data necessary for the execution of these programs. According to the first embodiment of this invention, the memory 27 is configured by a volatile medium.

The memory 27 stores a processing management module 100, an operating system 30, the processing data management module 111, the cluster information management module 118, the service information management module 121, the processing data 115, the processing request queue 116, the processing result information buffer 117, the cluster information table 120, the service information table 124, the service group information table 125, and the processing service group ID 126.

The processing management module 100 is a program executed by the operating system 30. The processing data management module 111, the cluster information management module 118, and the service information management module 121 are programs executed by the processing management module 100. The processing data management module 111, the cluster information management module 118, and the service information management module 121 execute the processing described referring to FIG. 1.

The processing data 115 is data used by various services. The processing data 115 may be managed by an application program such as a database management system, which is different from the processing data management module 111. In this case, the database management system is stored in the memory 27.

The processing request queue 116, as described referring to FIG. 1, is an area for storing processing contents included in a processing request message 200. The processing result information buffer 117, as described referring to FIG. 1, is an area for temporarily storing a result of a requested processing. Specifically, the processing result information buffer 117, on a server 110 in the status of “STANDBY SYSTEM”, temporarily stores a processing result transmitted by the server 110 in the status of “ACTIVE SYSTEM” until the result is reflected to the processing data 115.

The cluster information table 120, as described referring to FIG. 1, stores the addresses of the servers 110 of the transmission destination by means of the multicast communication and operating statuses of the servers 110. The service information table 124 stores, as described referring to FIG. 1, tables used for the respective services and load quantities. The service group information table 125, as described referring to FIG. 1, stores services belonging to service groups. As described referring to FIG. 1, the processing service group ID 126 holds identifiers of service groups assigned to the respective servers 110.

The display device 22 displays various information such as a result of processing a service. The keyboard 23 and the mouse 24 receive an input from the user. The NIC 25 is an interface used for connection to the network 103. The hard disk drive 26 stores processing data 115 to be stored in the memory 27 and various programs to be loaded on the memory 27.

Moreover, the hardware configuration of the client 101 is similar to the hardware configuration of the server 110 illustrated in FIG. 2, and the client 101 includes a CPU, a memory, an NIC, an input/output device, and the like. Moreover, the client 101 may be realized by a program executed on a virtual computer.

A description is now given of an overview of processing carried out according to the first embodiment of this invention.

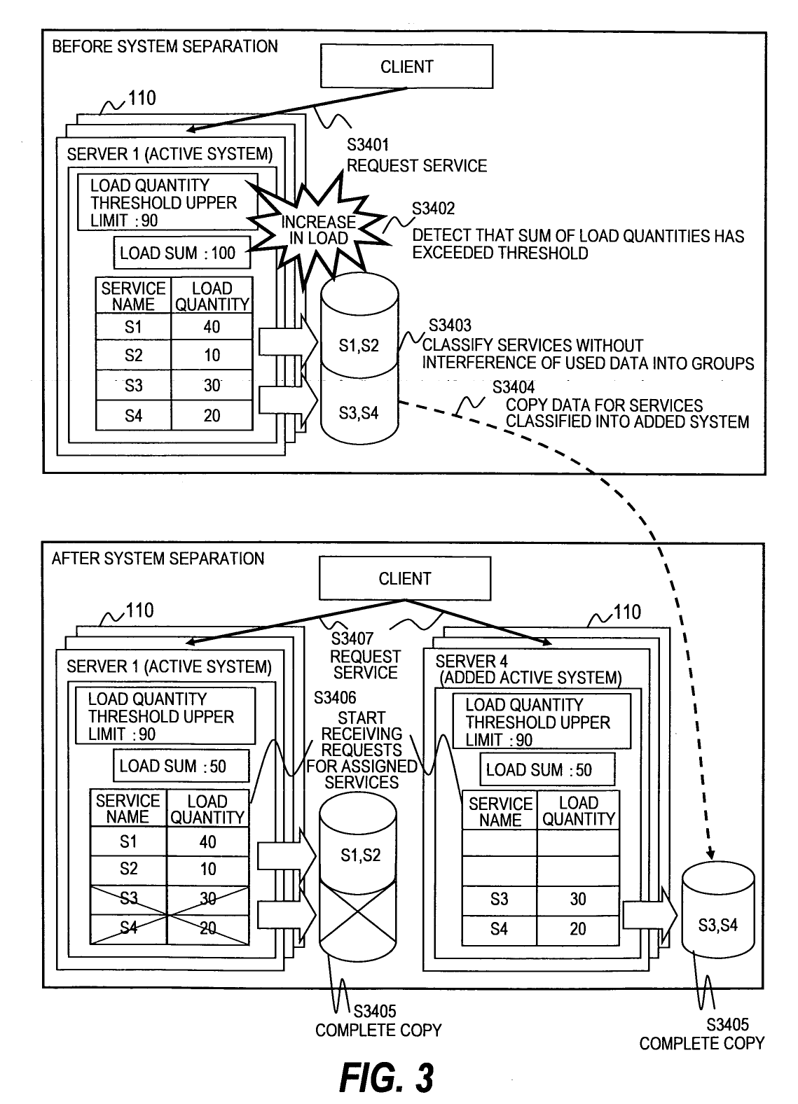

FIG. 3 is a diagram for describing the overview of steps of reorganizing the computer system according to the first embodiment of this invention.

According to the first embodiment of this invention, when a load imposed on a server 110 increases, services are separated according to a service group as a unit, thereby distributing the load to other servers 110. The distribution of a load by separating a system in this way is referred to as scale-out.

First, a description is now given of ordinary processing before execution of scale-out.

When servers 110 receive a service request transmitted via multicast from a client 101 (S3401), only a server 110 in the status of “ACTIVE SYSTEM” processes the received service request. The server 110, upon completion of the processing the requested service, records the load quantity of the processed service to the service information table 124. Each time the server 110 has processed a requested service, the server 110 determines whether the sum of the load quantities of services imposed on the server 110 which has processed the requested service has exceeded an upper limit of a load quantity threshold (S3402).

The server 110, upon detecting that the sum of the load quantities has exceeded the upper limit of the load quantity threshold in the processing in S3402, starts the scale-out.

The server 110 first classifies services so that data pieces used for resultant classified services do not mutually interfere with each other, and separates the classes of services from each other (S3403). For example, in FIG. 3, the services are classified into services S1 and S2, and services S3 and S4. Moreover, when a plurality of service groups are defined, the service groups may be selected.

The server 110 selects, out of the servers 110 included in the computer system, a plurality of servers 110 to be used for processing the services separated in the processing in S3403. On this occasion, a status of the selected servers 110 is set to “ADDED SYSTEM”. Moreover, data pieces used for the separated services (S3 and S4) are copied to the servers 110 in the status of “ADDED SYSTEM” (S3404). On this occasion, the server 110 in the status of “ACTIVE SYSTEM” may further receive requests for processing services, and thus, in order to prevent the load imposed on the server 110 in the status of “ACTIVE SYSTEM” from increasing, data is copied from a server 110 in the status of “STANDBY SYSTEM”.

When the separated service which uses the data has been processed while the data used for the separated services is being copied, processing result information of the process is transmitted via multicast. On this occasion, when the service is assigned to a server 110 which has received the information, the result of the processing is reflected, otherwise the received result of the processing is discarded. Moreover, when the data is being copied on the servers 110 in the status of “ADDED SYSTEM”, the result of the processing is reflected after the copy is completed. The above-mentioned processing can maintain the consistency of the data.

When the copy of the data in the processing in S3404 has been completed (S3405), one of the plurality of servers 110 in the status of “ADDED SYSTEM” is set to the status of “ACTIVE SYSTEM”, and the rest thereof are set to the status of “STANDBY SYSTEM”. Then, the added server 110 in the status of “ACTIVE SYSTEM” (server 4) starts receiving the separated services (S3406). Moreover, on the server 110 (server 1) from which the services have been separated, the processing for the separated services S3 and S4 is stopped. When the above-mentioned processing has been ended, the scale-out has been completed.

A description is now given of processing after the scale-out.

After the scale-out has been carried out, thereby separating the system through the processing from S3401 to S3406, the client 101, as before the scale-out, transmits a service request via multicast (S3407). The service request is transmitted via multicast, and hence the client 101 is not influenced by the scale-out of the servers 110. According to the first embodiment of this invention, all the servers 110 receive a service request, and a server 110 in the status of “ACTIVE SYSTEM”, upon receiving the assigned service request, processes the received service request, otherwise the server 110 discards the received service request.

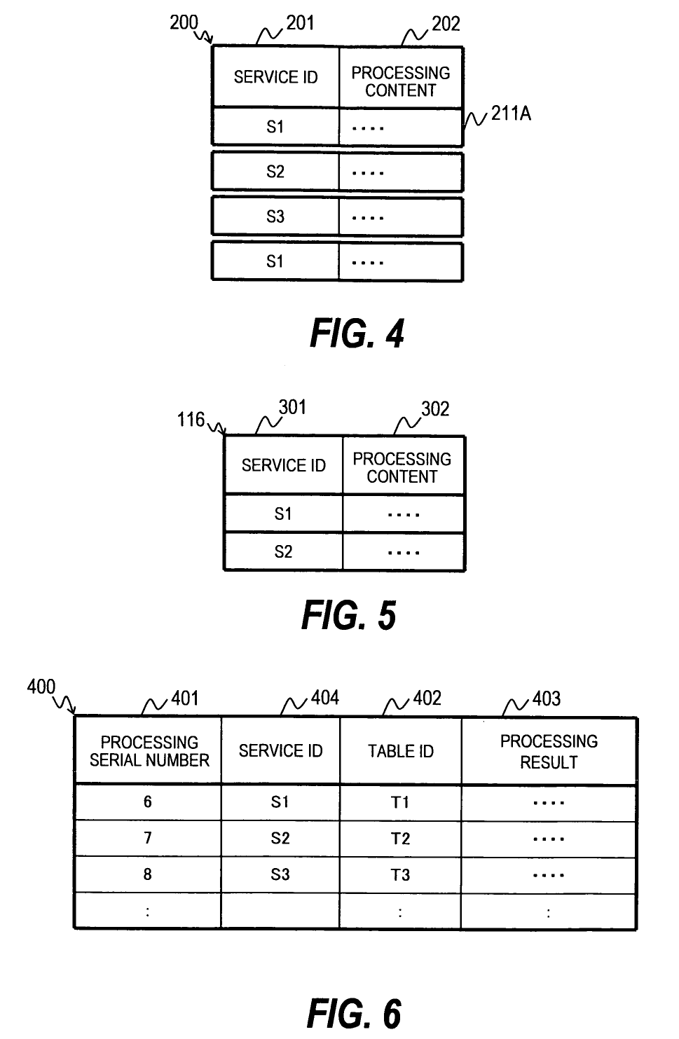

A detailed description is now given of the first embodiment of this invention. First, referring to FIGS. 4 to 13, a description is given of contents of tables and a queue according to the first embodiment of this invention.

FIG. 4 illustrates an example of the processing request message 200 according to the first embodiment of this invention.

The processing request message 200 is information transmitted when a client 101 requests a server 110 to process a service. The processing request message 200 includes a service ID 201 and a processing content 202.

The service ID 201 is an identifier for uniquely identifying a service for which the client 101 requests processing. The processing content 202 is information indicating contents of the processing of the service identified by the service ID 201. Specifically, the processing content 202 includes parameters necessary for processing the service.

The service ID 201 and the processing content 202 included in the processing request message 200 are to be registered to the processing request queue 116 of the server 110 which has received the processing request message 200.

FIG. 5 illustrates an example of a configuration of the processing request queue 116 according to the first embodiment of this invention.

The processing request queue 116 stores the information included in the processing request message 200 received by the server 110. The processing request queue 116 includes a service ID 301 and a processing content 302.

The service ID 301 includes a value of the service ID 201 included in the processing request message 200. The processing content 302 includes values of the processing content 202 included in the processing request message 200.

FIG. 6 illustrates an example of a configuration of processing result information 400 according to the first embodiment of this invention.

The processing result information 400 is a result of processing, which is performed by a server 110, of a processing request stored in the processing request queue 116. The processing result information 400 includes a processing serial number 401, a service ID 404, a table ID 402, and a processing result 403.

The processing serial number 401 is an identifier assigned to processing carried out for a processing request stored in the processing request queue 116 for uniquely identifying the completed processing.

The service ID 404 is an identifier of the processed service. The service ID 404 corresponds to the service ID 301 in the processing request queue 116. The table ID 402 is an identifier of a table used for processing the service identified by the service ID 404.

The processing result 403 stores a result of processing the service. Specifically, the processing result 403 is a result of processing data stored in the table corresponding to the table ID 402 the data being used for the service corresponding to the service ID 404. The processing in the service includes “UPDATING TABLE”, “PARTIALLY DELETING TABLE”, and “PARTIALLY ADDING TABLE”.

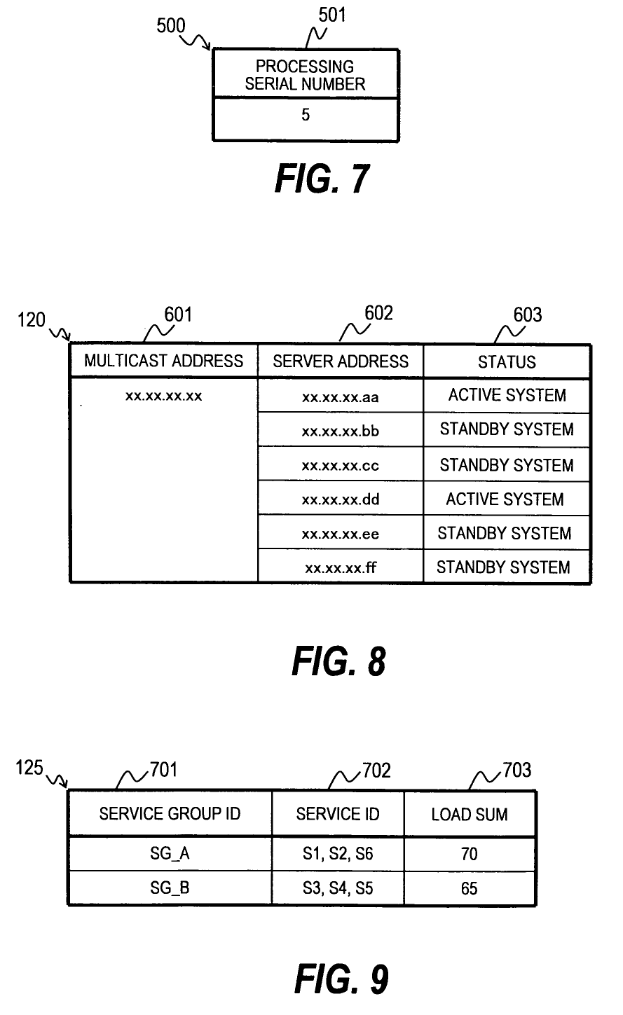

FIG. 7 illustrates an example of a processing serial number 500 according to the first embodiment of this invention.

The processing serial number 500 is incremented each time a server 110 processes a service, and is used to uniquely identify the processing carried out for the service. The processing serial number 500 is stored in the processing serial number 401 of the processing result information 400 illustrated in FIG. 4.

FIG. 8 illustrates an example of a configuration of the cluster information table 120 according to the first embodiment of this invention.

The cluster information table 120 holds relationships between a cluster and servers 110. The cluster information table 120 includes a multicast address 601, a server, address 602, and a status 603.

The multicast address 601 is a multicast address shared in a cluster including servers 110. This means that the plurality of servers 110 in the cluster are participating in a membership of the multicast address.

The server address 602 is an address used for transmitting information to a server 110. To the server address 602, an address unique to each server 110 such as an IP address is assigned.

The status 603 represents a status of the server 110. Specifically, to the status, values such as “ACTIVE SYSTEM”, “STANDBY SYSTEM”, and “ADDED SYSTEM” are assigned.

FIG. 9 illustrates an example of a configuration of the service group information table 125 according to the first embodiment of this invention.

The service group information table 125 holds relationships between a service group and services constituting the service group. A service group is created by grouping services which use common tables for their processing so that the sums of loads imposed by respective groups of the services are equivalent. According to the first embodiment of this invention, a group of services using common tables for their processing is defined as a service group, and service groups are assigned to the respective servers, but the individual services may be directly assigned to the respective servers instead of the service groups.

The service group information table 125 includes a service group ID 701, a service ID 702, and a load sum 703.

The service group ID 701 is an identifier for uniquely identifying a service group. The service ID 702 represents a service constituting the service group. The load sum 703 is a value obtained by summing load quantities imposed by the respective services constituting the service group.

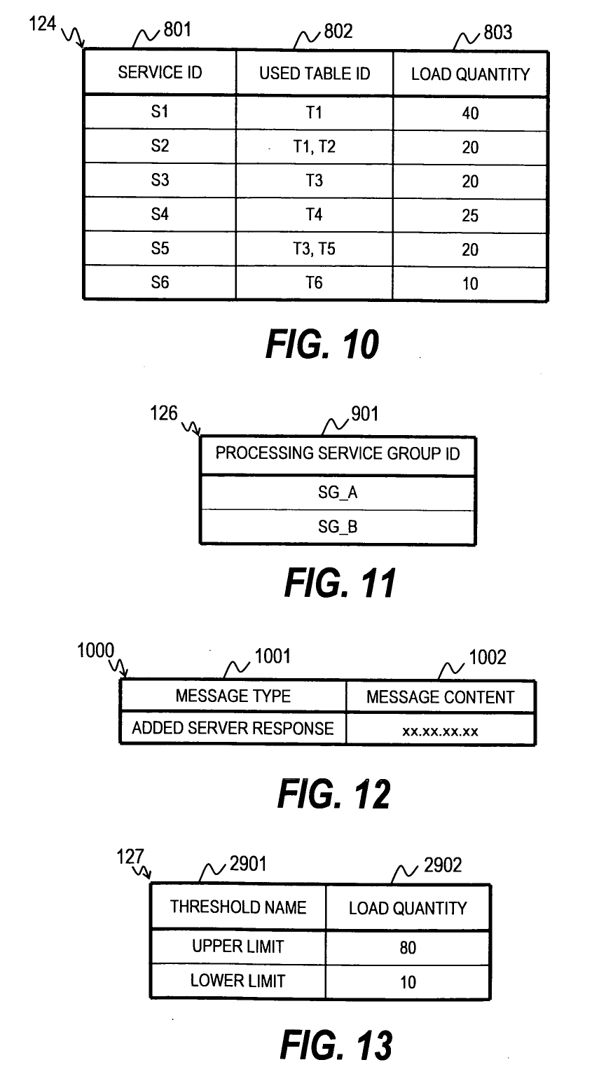

FIG. 10 illustrates an example of a configuration of the service information table 124 according to the first embodiment of this invention.

The service information table 124 holds relationships between a service and tables used for the service. The service information table 124 includes a service ID 801, a used table ID 802, and a load quantity 803.

The service ID 801 is an identifier for uniquely identifying a service. The used table ID 802 is an identifier of a table storing data used for the service.

The load quantity 803 is information on a load imposed by processing the service. The load quantity 803 is calculated according to information available from a server 110, such as a CPU usage, a memory usage, a frequency of input/output processing, and a frequency of lock processing during the service processing.

FIG. 11 illustrates an example of the processing service group ID 126 according to the first embodiment of this invention.

The processing service group ID 126 is a list of service groups processed by a server 110.

FIG. 12 illustrates an example of a configuration of an added server response request message 1000 according to the first embodiment of this invention.

The added server response request message 1000 includes a message type 1001 and a message content 1002. The message type 1001 is information indicating whether the message is “RESPONSE REQUEST” or “RESPONSE”. The message content 1002 stores, when the message is the “RESPONSE” type, an address of a server 110 to which the message is transmitted.

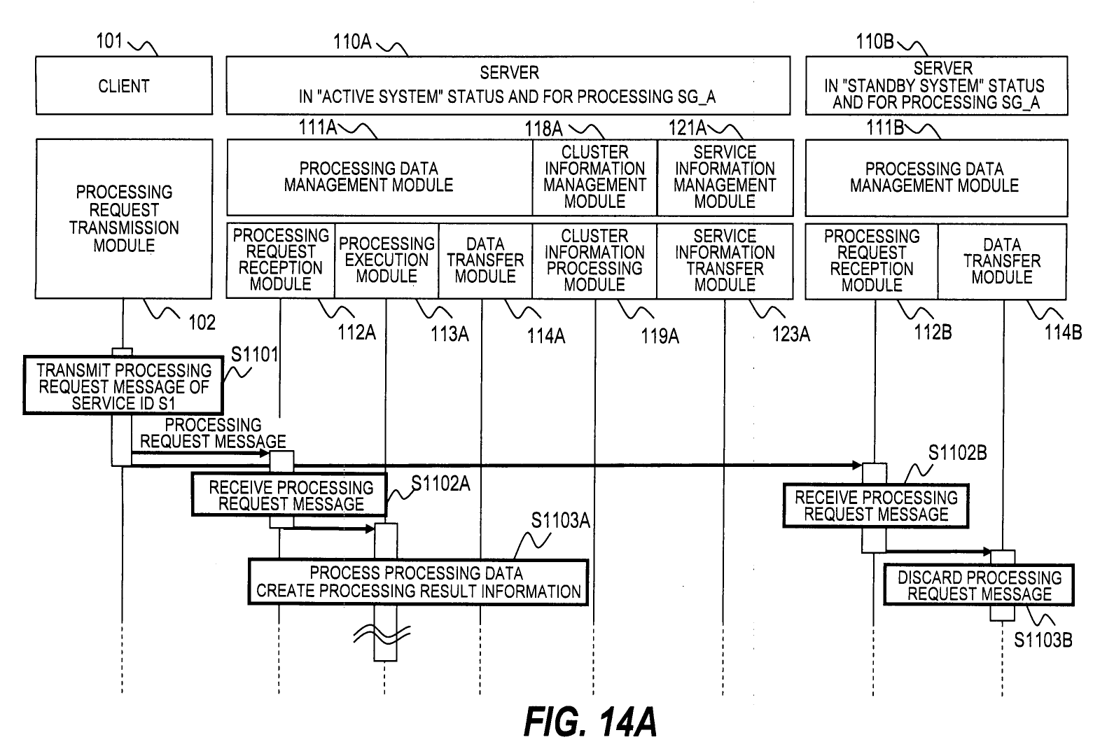

FIG. 13 illustrates an example of a configuration of the load quantity threshold table 127 according to the first embodiment of this invention.

The load quantity threshold table 127 includes a threshold name 2901 and a load quantity 2902.

The threshold name 2901 represents a type of load quantity threshold such as “UPPER LIMIT” and “LOWER LIMIT”.

The load quantity 2902 represents a load quantity corresponding to the threshold name 2901. In FIG. 13, a load quantity 2902 of a threshold name 2901 of “UPPER LIMIT” is 80, and a load quantity 2902 of a threshold name 2901 of “LOWER LIMIT” is 10.

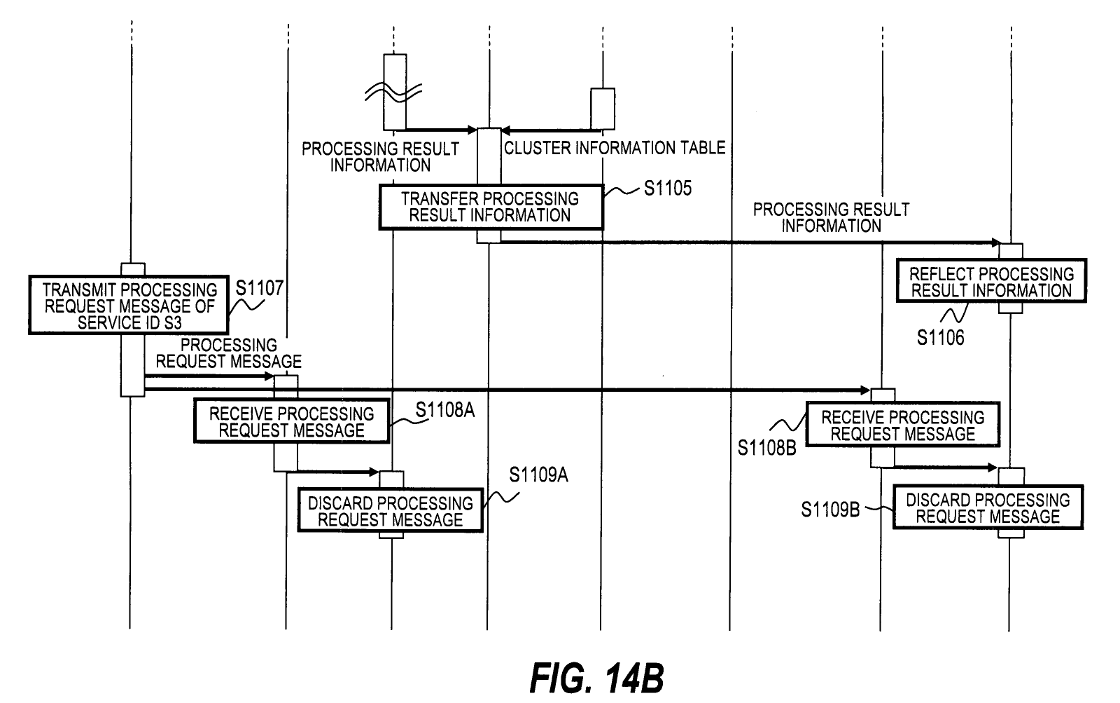

A description is now given of steps of processing according to the first embodiment of this invention referring to FIGS. 14A to 20.

FIGS. 14A and 14B describe steps of processing carried out on servers 110 in response to processing requests transmitted from a client 101 according to the first embodiment of this invention.

FIGS. 14A and 14B illustrate steps in which the client 101 requests a cluster including a server 110A and a server 110B for processing. Moreover, in the requested processing, a service which belongs to a service group having the service group ID of SG_A, and has the service ID of S1 is carried out.

The client 101 transmits a processing request message 211A in order to request execution of the service having the service ID of S1 to servers 110 (S1101). The processing request message 211A includes a value “S1” in the service ID 301. A transmission destination of the processing request message 211A is a multicast address assigned to the cluster including the server 110A and the server 110B.

A processing request reception module 112A of the server 110A receives the processing request message 211A, and transmits a processing request message to a processing execution module 113A (S1102A).

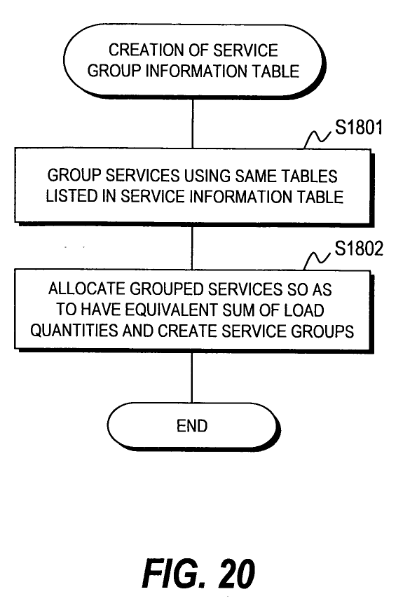

The processing execution module 113A refers to the service ID 301 and the processing content 302 stored in the processing request message transmitted from the processing request reception module 112A (S1103A). Further, the processing execution module 113A, as described later referring to FIG. 20, when the received processing request message 200 is to be processed, executes the requested processing, otherwise the processing execution module 113A discards the received processing request message 200.

In the example illustrated in FIGS. 14A and 14B, to the server 11A, the service group having the service group ID of SG_A is assigned, and the service having the service ID of S1 belongs to the service group SG_A. Hence, the server 110A processes the service based on the received processing request message 200. The processing execution module 113A, in the processing in S1103A, executes the service S1 based on the processing content 302 included in the processing request message 200, and creates processing result information 400.

The processing execution module 113A transmits the processing result information 400 to a data transfer module 114A. The data transfer module 114A refers to the multicast address 601 in the cluster information table 120, and transmits the processing result information 400 transmitted by the processing execution module 113A via multicast.

Moreover, a processing request reception module 112B of the server 110B, upon receiving the processing request message 200 from the client 101 as a result of the processing in S1101, carries out processing in the same manner as the processing in S1102A performed by the processing request reception module 112A of the server 110A (S1102B). The server 110B is in the status of “STANDBY SYSTEM”, and hence the processing request message 200 received by the server 110B is discarded in processing in S1103B.

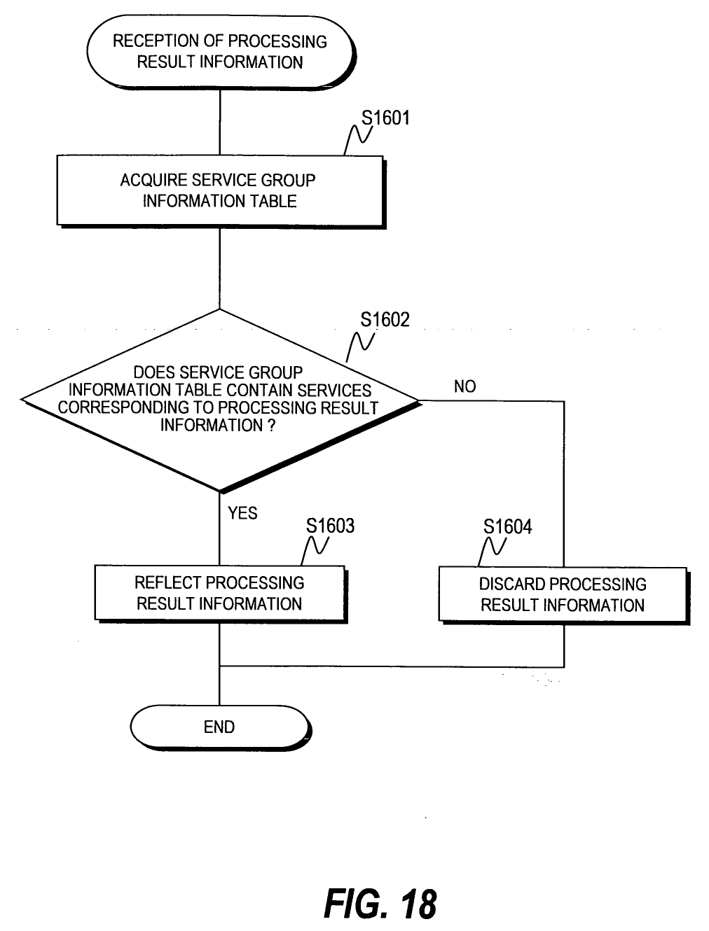

A data transfer module 114B of the server 110B receives the processing result information 400 transmitted by the data transfer module 114A of the server 110A as a result of the processing in S1105 (S1106). Then, the data transfer module 114B determines, as described later referring to FIG. 18, whether to update processing data 115 based on the received processing result information 400. When the processing data 115 is to be updated, the data transfer module 114B updates the processing data 115 based on the processing result 403 included in the processing result information 400, thereby causing the processing data 115 to coincide with processing data in the server 110A. When the processing data 115 is not to be updated, the data transfer module 114B discards the received processing result information 400.

In the example illustrated in FIGS. 14A and 14B, the server 110B is in the state of “STANDBY SYSTEM” for the server 110A, and, in order to store the identical data, based on the processing result 403, updates the processing data 115.

A description is now given of a case in which a processing request message 200 for requesting execution of a service having the service ID of S3, which does not belong to the service group having the service group ID of SG_A, is received.

The client 101, in the same manner as the processing in S1101, transmits the processing request message 200 (S1107). On this occasion, to the service ID 301 of the transmitted processing request message 200, “S3” is set.

The processing request reception module 112A of the server 110A receives the processing request message 200 transmitted by the client 101 (S1108A). On this occasion, S3 is set to the service ID included in the processing request message 200, and this service is not included in the service group SG_A assigned to the server 11A. Hence, the processing execution module 113A discards the received processing request message 200.

The processing request reception module 112B of the server 110B, as in S1108A and S1109A, receives the processing request message 200 (S1108B), and, as in S1103B, the data transfer module 114B discards the received processing request message 200 (S1109B).

A description is now given of steps of distributing a load exceeding an upper limit on a server 110 in the status of “ACTIVE SYSTEM” by carrying out the scale-out for adding a server 110 in the status of “ACTIVE SYSTEM”.

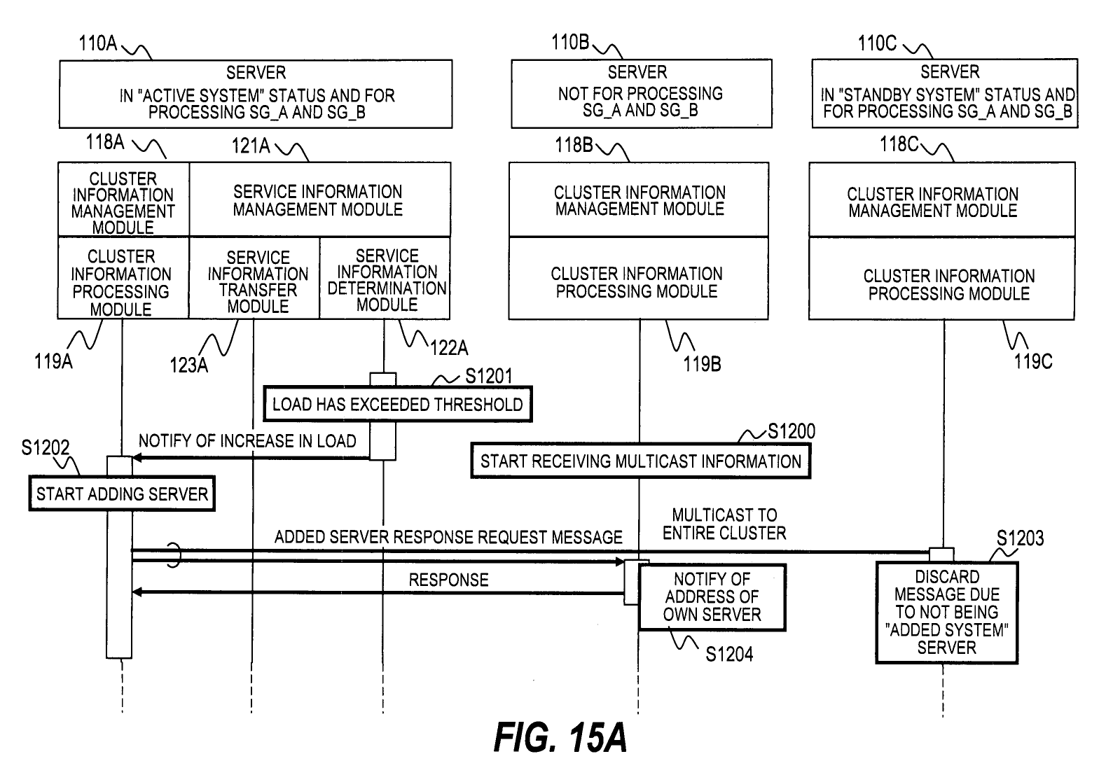

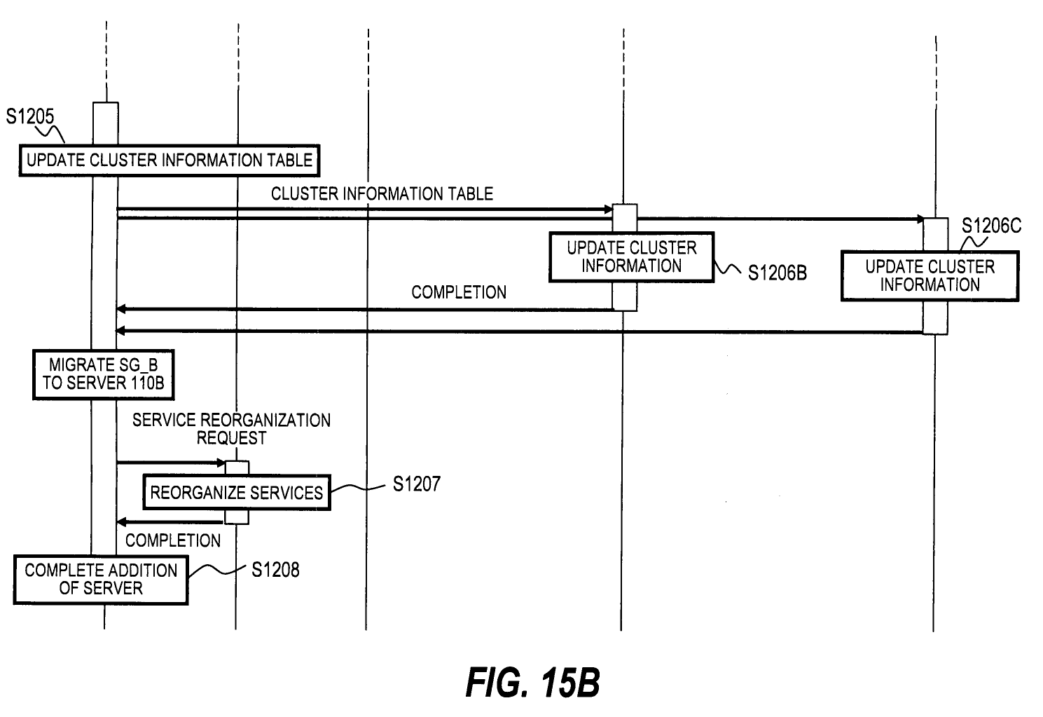

FIGS. 15A and 15B describe steps of adding the server 110 in the status of “ACTIVE SYSTEM” to a cluster (scale-out) according to the first embodiment of this invention.

Before the description of the processing steps illustrated in FIGS. 15A and 15B, a description is given of a configuration of the subject cluster. In FIGS. 15A and 15B, a server 110A in the status of “ACTIVE SYSTEM” and a server 110C in the status of “STANDBY SYSTEM” are included in the same cluster, and both of the servers 110A and 110C process a service group SG_A. It should be noted that, on this occasion, all services processed by the server 110A belong to the service group SG_A.

A description is now given of steps of, when a load imposed on the server 110A in the status of “ACTIVE SYSTEM” increases, carrying out reorganization such that the service group SG_A is separated to create a service group SG_B, and services included in the service group SG_B are processed by the server 110B.

A service information determination module 122A of the server 110A in the status of “ACTIVE SYSTEM”, upon detecting that the load imposed on the server 110A has exceeded the predetermined threshold (upper limit), notifies a cluster information processing module 119A of the excessive load (S1201). Specifically, the service information determination module 122A calculates the load quantity based on the CPU usage, the memory usage, an input/output processing quantity, and the like included in a system log of the server 110A and the like, and compares the load quantity with the threshold (upper limit in this case) set to the load quantity threshold table 127.

The cluster information processing module 119A, upon receiving the notification that the load has exceeded the upper limit from the service information determination module 122A, transmits an added server response request message 1000 to all the servers 110 in the cluster via multicast (S1202).

The server 110C, on this occasion, is in the status of “STANDBY SYSTEM”, and is to process the service group SG_A before the separation. Thus, the processing service group ID 126 of the server 110C includes the service group SG_A.

A cluster information processing module 119C included in a cluster information management module 118C of the server 110C receives the added server response request message 1000 transmitted from the server 110A via multicast (S1203). The own server 110C is not in the status of “ADDED SYSTEM”, and hence the cluster information processing module 119C discards the message.

The server 110B has started receiving the information transmitted via multicast (S1200). On this occasion, the server 110B is not to process the service groups SG_A and SG_B. In other words, the processing service group ID 126 of the server 110B does not include the service group SG_A. When the load exceeding the threshold is detected in S1201, for example, the server 110B may be added to the membership of the multicast address, and the multicast communication may start. On this occasion, servers 110 to be added may be pooled in the computer system in advance, and when the scale-out is carried out, a server 110 may be added to the cluster.

The server 110B receives, from the server 110A, the added server response request message 1000 transmitted via multicast (S1204). A cluster information processing module 119B transmits a response to the server 110A, which is the source of transmission of the added server response request message 1000, in the processing in S1204. On this occasion, in the response to be transmitted, an address of the own server (server 110B) is stored.

When the server 110A receives the response transmitted from the server 110B, the server 110A updates, based on the received response, the cluster information table 120, and transmits the updated information to all the servers 110 in the cluster (S1205). Specifically, the server 110A adds the address of the server 110B included in the response to the cluster information table 120, and sets the status of the added server 110B to “ADDED SYSTEM”.

The cluster information processing module 119 of the server 110, upon receiving the cluster information, updates contents of the cluster information table 120 of the own server based on the transmitted cluster information so that the contents are identical to those of the cluster information table 120 of the server 110A (S1206B and S1206C). After the update of the cluster information table 120, the cluster information processing module 119 notifies the server 110A of the completion of the update of the cluster information.

After the server 110A has received the notification of the completion of the cluster information update from all the servers 110 to which the cluster information has been transmitted, the server 110A transmits a service reorganization request to a service information transfer module 123A of the own server 110A.

On this occasion, as described later referring to FIG. 20, based on the service information table 124, the services are grouped according to tables used for executing the services. On this occasion, the grouping is carried out so that the sums of load quantities of the respective service groups are as equivalent as possible. Then, new service groups are defined, and the service group information table 125 is updated. According to the first embodiment of this invention, from the service group SG_A, the service group SG_B is created, and, to the service group information table 125, records corresponding to the service groups SG_A and SG_B are registered.

When the service groups SG_A and SG_B are separately registered on the server 110A in advance, and a difference between the load sum 703 of the service group SG_A and the load sum 703 of the service group SG_B is small, it is possible to carry out subsequent processing without creating a new service group.

The service information transfer module 123A, upon receiving the service reorganization request from the cluster information processing module 119A, carries out the service reorganization processing (S1207), and transmits a notification of completion of the reorganization to the cluster information processing module 119A.

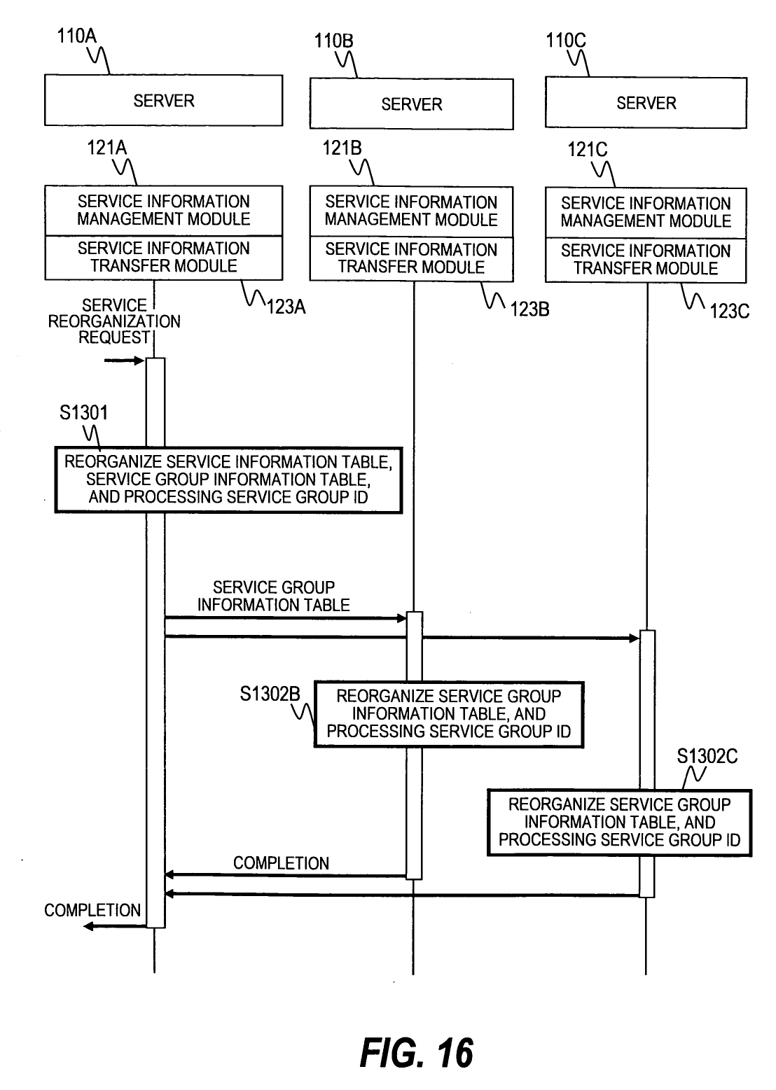

A description is later given of the service reorganization processing in S1207 referring to FIG. 16. When the service reorganization processing is carried out, in the respective processing service group IDs 126 of the servers 110A and 110C, SG_A and SG_B are stored, and in the processing service group ID 126 of the server 110B, SG_B is stored. Further, the service information tables 124 of the respective servers 110 are reorganized so as to store the service IDs 801 belonging to the processing service group ID 126.

Thus, as a result of the processing in S1207, the service group information table 125, the service information table 124, and the processing service group ID 126 of the servers 110A and 110C are updated respectively as illustrated in FIGS. 9, 10, and 11. Moreover, those of the server 110B are updated respectively as illustrated in FIGS. 26, 24, and 28. The cluster information processing module 119A receives the notification of completion from the service information transfer module 123A, and the addition of server 110 is completed (S1208).

On this occasion, the server 110A repeats the above-mentioned processing of adding a server 110 (S1202 to S1208) as many times as the number of servers 110 to be added set in advance. The number of servers 110 to be added may be one or more. According to the first embodiment of this invention, the number of servers 110 to be added is three, and, in the following description, three servers 110 are added as servers in the status of “ADDED SYSTEM”.

FIG. 16 describes steps of the service reorganization processing (S1207) according to the first embodiment of this invention.

The service reorganization processing, as described above, is carried out by the service information transfer module 123A of a service information management module 121A.

The service information transfer module 123A, based on the received service reorganization request, reorganizes the service information table 124, the service group information table 125, and the processing service group ID 126 (S1301).

Then, the service information transfer module 123A transmits the service information table 124, the service group information table 125, and the processing service group ID 126 to all the servers 110 in the cluster. On this occasion, the service information transfer module 123A may transmit the same contents, or select and transmit information necessary for update in the respective servers 110.

A service information transfer module 123B included in a service information management module 121B of the server 110B receives the service information table 124, the service group information table 125, and the processing service group ID 126 transmitted from the service information transfer module 123A. Then, the service information transfer module 123B, based on the received information, updates the respective tables of the own server 110B, and notifies the service information transfer module 123A of the completion of the update (S1302B).

A service information transfer module 123C included in a service information management module 121C of the server 110C, in the same manner as the processing in S1302B, updates the respective tables of the own server 110C, and notifies the service information transfer module 123A of the completion of the update (S1302C).

The service information transfer module 123A, upon having received the notification of completion from the respective servers 110B and 110C, ends the service reorganization.

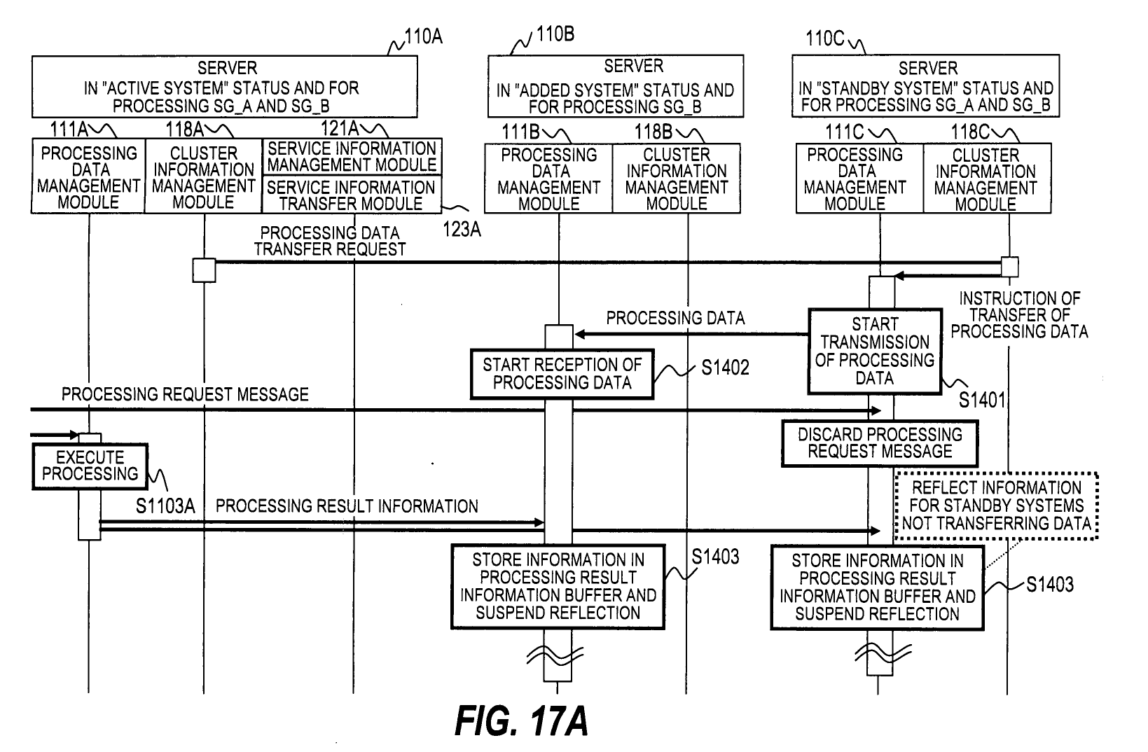

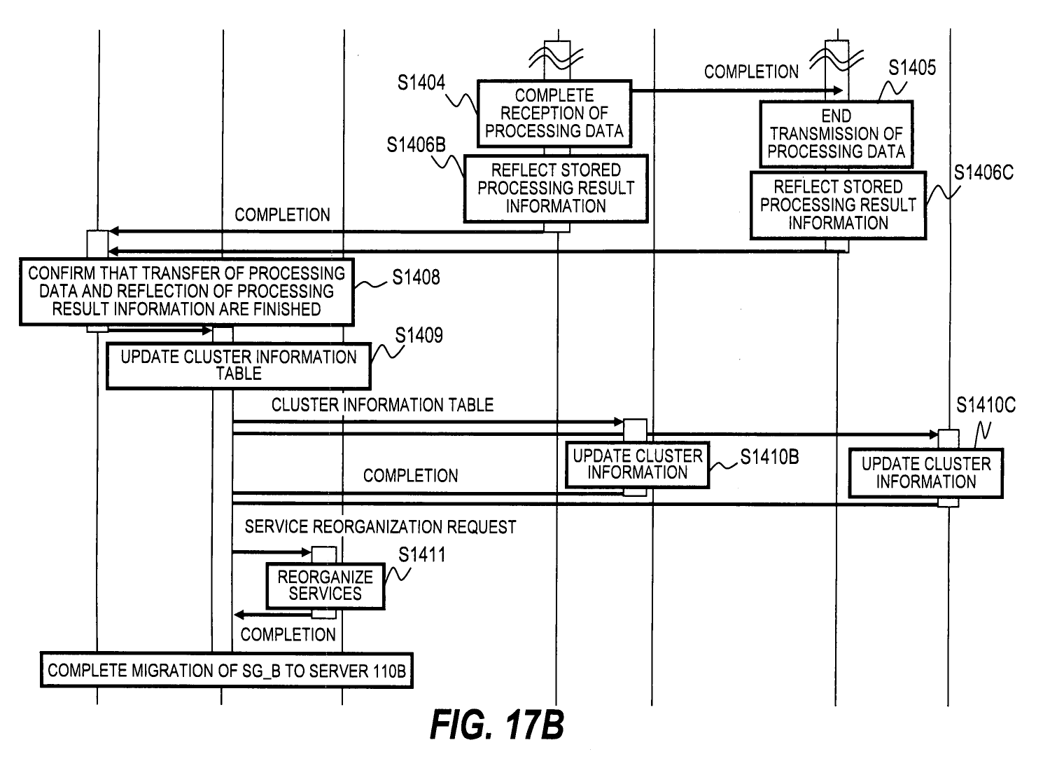

A description is now given of steps of transferring processing data to a server 110 in the status of “ADDED SYSTEM”, and steps of transferring a processing result when a service is processed while the processing data is being transferred referring to FIGS. 17A and 17B.

FIGS. 17A and 17B describe the steps of transferring the processing data to the server 110B in the status of “ADDED SYSTEM” according to the first embodiment of this invention.

Before the processing illustrated in FIGS. 17A and 17B are carried out, it is assumed that the processing of adding the server 110 described referring to FIGS. 15A and 15B has been completed, and the same cluster includes the server 110A in the status of “ACTIVE SYSTEM”, the server 110B in the status of “ADDED SYSTEM”, and the server 110C in the status of “STANDBY SYSTEM”. In FIGS. 17A and 17B, a description is given of a case in which, from the server 110A or 110C, processing data used for a service belonging to the service group SG_B is transferred.

A cluster information management module 118A of the server 110A first transmits a processing data transfer request for requesting one of the servers 110C in the status of “STANDBY SYSTEM” to transfer the processing data to the server 110B. It should be noted that the server 110A in the status of “ACTIVE SYSTEM” may transfer the processing data to the server 110B. In this case, the server 110A does not transmit the processing data transfer request to the server 110C, and processing starting from S1401 is carried out by the server 110A.

The cluster information management module 118C of the server 110C receives the processing data transfer request transmitted by the cluster information management module 118A, and instructs a processing data management module 111C of the server 110C to transfer the processing data.

The processing data management module 111C of the server 110C, upon receiving the instruction to transfer the processing data, starts transmitting the processing data 115 to the server 110B (S1401). Then, the status of the server 110C is set to “TRANSFERRING PROCESSING DATA”.

A processing data management module 111B of the server 110B starts receiving the processing data 115 transmitted from the server 110C (S1402). Then, the status of the server 110B is set to “TRANSFERRING PROCESSING DATA”.

A processing data management module 111A of the server 110A, upon receiving a processing request message 200 transmitted by a client 101, in the same manner as the processing in S1103A of FIG. 14A, carries out requested processing. The cluster information management module 118A of the server 110A transmits processing result information 400 to the servers 110 in the same cluster via multicast.

When the servers 110B and 110C in the status of “TRANSFERRING PROCESSING DATA” receive the processing result information 400 from the server 110A, the servers 110B and 110C store the received processing result information 400 in the processing result information buffer 117, and suspend reflection of the processing result (S1403).

The processing data management module 111B of the server 110B, upon having completed the reception of the processing data transmitted from the processing data management module 111C of the server 110C, notifies the server 110C of the completion of the reception of the processing data (S1404).

The processing data management module 111C of the server 110C, upon receiving the notification of the processing data reception completion from the processing data management module 111B, ends the transmission of the processing data (S1405). On this occasion, by deleting the transmitted processing data from the memory 27, a used memory resource may be reduced.

The processing data management module 111B and the processing data management module 111C, upon the completion of the transfer of the processing data, cancel the status of “TRANSFERRING PROCESSING DATA”. When the status of “TRANSFERRING PROCESSING DATA” is canceled, the status of the server 110B is set to “ADDED SYSTEM”, and the status of the server 110C is set to “STANDBY SYSTEM”. Further, in the same manner as the processing in S1106 of FIG. 14B, the processing data management modules 111B and 111C reflect the processing result information 400 stored in the processing result information buffer 117 to the processing data 115, and notify the processing data management module 111A of the completion of the reflection (S1406B, S1406C).

The processing data management module 111A of the server 110A receives the notification that the processing result information has been reflected from the server 110B in the status of “ADDED SYSTEM” and the server 110C which is the destination of the transmission of the processing data transfer request, and thus, confirms that the processing data has been transferred, and the result of the processing has been reflected (S1408).

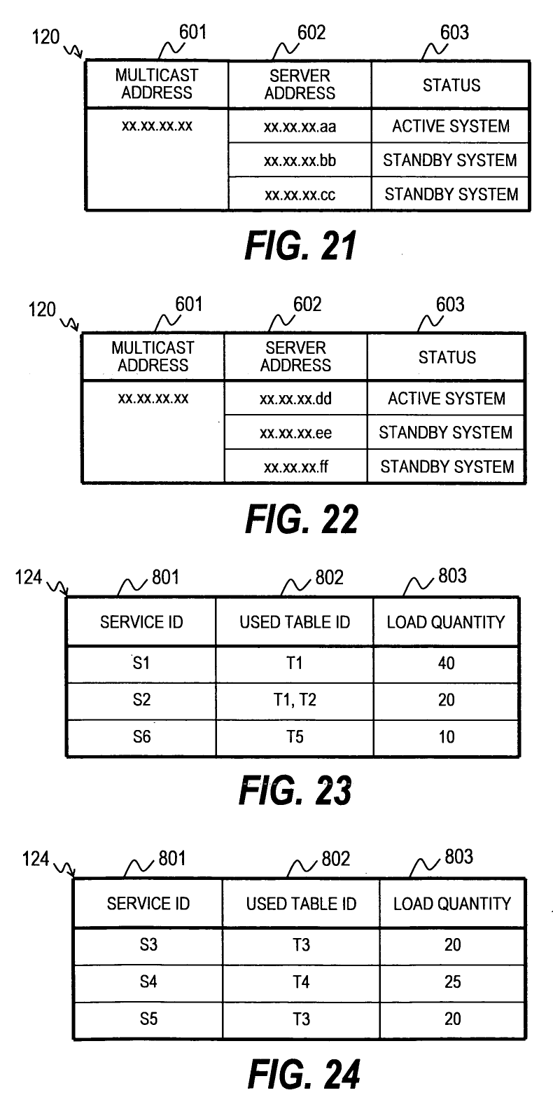

The cluster information management module 118A of the server 110A creates and updates cluster information tables 120 (S1409). Specifically, the cluster information management module 118A refers to the statuses 603 of the cluster information table 120, and creates the cluster information tables 120 respectively for the servers 110 in the status of “ADDED SYSTEM” and for the servers 110 in the other statuses (statuses of the existing system). The created cluster information tables 120 are as illustrated in FIG. 21 for the existing systems, and as illustrated in FIG. 22 for “ADDED SYSTEM”. Moreover, when the cluster information table 120 for “ADDED SYSTEM” is created, one server 110 is set to “ACTIVE SYSTEM”, and the other servers 110 are set to “STANDBY SYSTEM”.

The cluster information management module 118A of the server 110A, as illustrated in FIG. 21, updates the cluster information table 120, and further, transfers the created cluster information tables 120 to the servers 110B and 110C. The server 110B updates the cluster information table 120 as illustrated in FIG. 22 (S1410B). The server 110C updates the cluster information table 120 as illustrated in FIG. 21 (S1410C).

The cluster information management module 118A of the server 110A transmits a service reorganization request to the service information transfer module 123A of the service information management module 121A.

The service information transfer module 123A carries out the service reorganization processing illustrated in FIG. 16, and notifies the cluster information management module 118A of the completion thereof (S1411).

In the service reorganization processing, the processing service group ID 126, the service information table 124, and the service group information table 125 are reorganized so that the server 110A and the server 110C process only the services belonging to the service group SG_A.

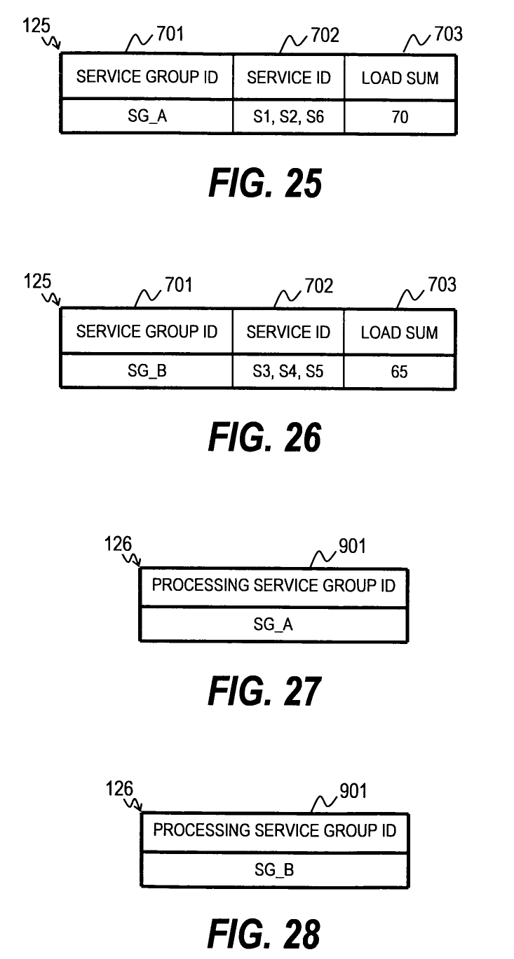

Specifically, on the server 110A and the server 110C, to the processing service group ID 126, SG_A is set (FIG. 27), to the service information table 124, the services belonging to the service group SG_A are set (FIG. 23), and to the service group information table 125, SG_A is set (FIG. 25).

It should be noted that, for the server 110B, it is not necessary to reorganize the service group ID 126, the service information table 124, and the service group information table 125. On this occasion, on the server 110B, to the processing service group ID 126, SG_B is set (FIG. 28), to the service information table 124, the services belonging to the service group SG_B are set (FIG. 24), and to the service group information table 125, SB_B is set (FIG. 26).

Finally, the cluster information management module 118A, upon receiving a notification of the completion of the service reorganization, completes the migration of the service group SG_B to the server 110B.

A description is now given of processing after the migration of the service group SG_B has been completed.

After the scale-out, base on the cluster information table 120, the respective servers 110 operate as the servers 110 in the statuses of “ACTIVE SYSTEM” and “STANDBY SYSTEM”. When a server 110 in the status of “ACTIVE SYSTEM” receives a processing request message 200 from a client 101, and, as in the description of the processing in S1103A of FIG. 14A, a service is to be processed, the server 110 processes the service, and transfers processing result information 400 to the other servers 110 via multicast. When the server 110 in the status of “STANDBY SYSTEM” receives the processing result information 400 transmitted via multicast, and, as in the description of the processing in S1106 of FIG. 14B, the received processing result information 400 needs to be reflected to the processing data 115, the server 110 updates, based on the received processing result information 400, the processing data 115. When the received processing result information 400 does not need to be reflected to the processing data 115, the server 110 discards the received processing result information 400. Moreover, the processing request message 200 received by the server 110 in the status of “ACTIVE SYSTEM” does not include a service to be processed, as in the description of S1108A of FIG. 14B, the server 110 discards the received processing request message 200.

FIG. 18 is a flowchart illustrating steps of reflecting processing result information to processing data according to the first embodiment of this invention. This processing corresponds to the processing in S1106 of FIG. 14B.

The data transfer module 114 of the server 110, upon receiving the processing result information 400, requests the service information transfer module 123 of the service information management module 121 to acquire the service group information table 125 (S1601). By referring to the service group information table 125 acquired by the processing in S1601, a service group to be processed by the server 110 which has received the processing result information 400 can be identified.

Then, the processing execution module 113 of the server 110 searches the service group information table 125, thereby determining whether a service ID 404 included in the processing result information 400 coincides with the service ID 702 included in the service group information table 125 (S 1602). When the service ID 404 included in the processing result information 400 coincides with the service ID 702 included in the service group information table 125 (“Yes” in S1602), the processing execution module 113 reflects a processing result 403 included in the processing result information 400 to the processing data 115 (S1603). When the service ID 404 included in the processing result information 400 does not coincide with the service ID 702 included in the service group information table 125 (“No” in S1602), the processing execution module 113 discards the received processing result information 400 (S1604).

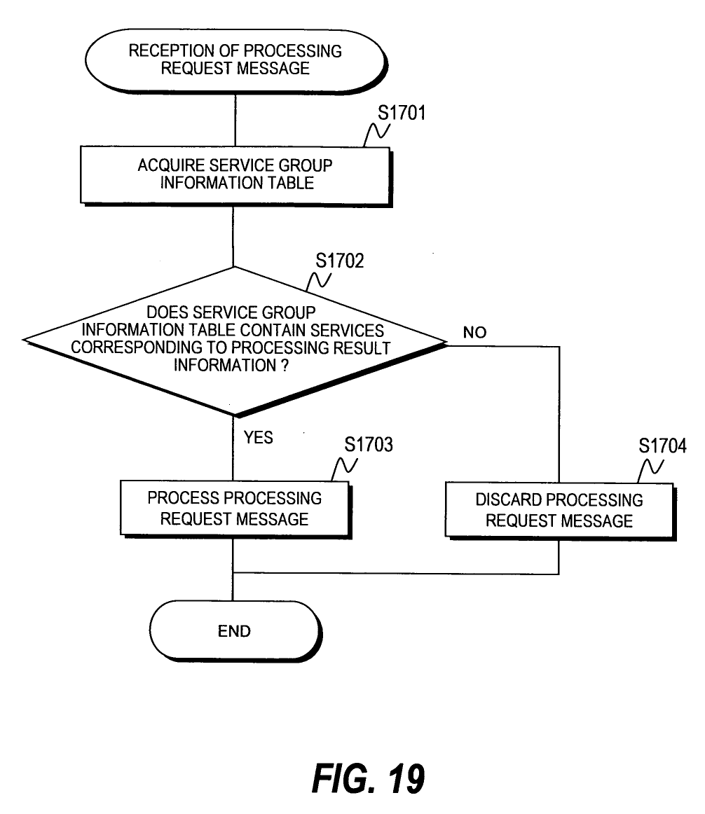

FIG. 19 is a flowchart illustrating steps of receiving a processing request message according to the first embodiment of this invention. This processing corresponds to the processing in S1103A of FIG. 14A.

The data transfer module 114 of the server 110, upon receiving the processing request message 200, requests the service information transfer module 123 of the service information management module 121 to acquire the service group information table 125 (S1701). By referring to the service group information table 125 acquired by the processing in S1701, a service group to be processed by the server 110 which has received the processing request message 200 can be identified.

Then, the processing execution module 113 of the server 110 searches the service group information table 125, and determines whether the service requested for processing is included in the service group information table 125 (S1702). When the services requested for processing is included in the service group information table 125 (“Yes” in S1702), the processing execution module 113, based on the received processing request message 200, executes the requested processing (S1703). When the services requested for processing is not included in the service group information table 125 (“No” in S1702), the processing execution module 113 discards the received processing request message 200 (S1704).

FIG. 20 is a flowchart illustrating steps of creating the service group information table 125 according to the first embodiment of this invention. This processing corresponds to the processing in S1201 of FIG. 15A.

The service information determination module 122 of the server 110, upon detecting that the load imposed on a server 110 has exceeded a threshold, executes processing of creating a service group information table 125. First, the service information determination module 122 groups service IDs having the same value of the used table IDs 802 in the service information table 124 (S1801). The processing in S1801 can divide the services into the plurality of groups of services using tables which interfere with each other, that is, using common tables.

Then, the service information determination module 122 of the server 110 creates as many service group IDs 701 as the number of the newly created service groups. The number of service group IDs 701 to be created is set in advance. Further, the services grouped by the processing in S1801 are distributed so that the sums of loads are made even as much as possible between the respective service groups (S1802). For example, groups of services are distributed in a descending order of the sum of load quantities to a service group having a smaller load sum 703. In this way, the service group information table 125 is created so that the tables used by the services do not interfere with each other, and the respective load sums 703 are more even.

FIG. 21 illustrates contents of the cluster information table 120 for the existing systems after the scale-out according to the first embodiment of this invention.

The configuration of the cluster information table 120 illustrated in FIG. 21 is the same as that of the cluster information table 120 illustrated in FIG. 8. Moreover, data stored in the cluster information table 120 illustrated in FIG. 21 is as described in the processing in S1409 of FIG. 17B.

FIG. 22 illustrates contents of the cluster information table 120 for the added systems after the scale-out according to the first embodiment of this invention.

The configuration of the cluster information table 120 illustrated in FIG. 22 is the same as that of the cluster information table 120 illustrated in FIG. 8. Moreover, data stored in the cluster information table 120 illustrated in FIG. 22 is as described in the processing in S1409 of FIG. 17B.

FIG. 23 illustrates contents of the service information table 124 for the existing systems after the scale-out according to the first embodiment of this invention.

The configuration of the service information table 124 illustrated in FIG. 23 is the same as that of the service information table 124 illustrated in FIG. 10. Moreover, data stored in the service information table 124 illustrated in FIG. 23 is as described in the processing in S1411 of FIG. 17B.

FIG. 24 illustrates contents of the service information table 124 for the added systems after the scale-out according to the first embodiment of this invention.

The configuration of the service information table 124 illustrated in FIG. 24 is the same as that of the service information table 124 illustrated in FIG. 10. Moreover, data stored in the service information table 124 illustrated in FIG. 24 is as described in the processing in S1411 of FIG. 17B.

FIG. 25 illustrates contents of the service group information table 125 for the existing systems after the scale-out according to the first embodiment of this invention.

The configuration of the service group information table 125 illustrated in FIG. 25 is the same as that of the service group information table 125 illustrated in FIG. 9. Moreover, data stored in the service group information table 125 illustrated in FIG. 25 is as described in the processing in S1411 of FIG. 17B.

FIG. 26 illustrates contents of the service group information table 125 for the added systems after the scale-out according to the first embodiment of this invention.

The configuration of the service group information table 125 illustrated in FIG. 26 is the same as that of the service group information table 125 illustrated in FIG. 9. Moreover, data stored in the service group information table 125 illustrated in FIG. 26 is as described in the processing in S1411 of FIG. 17B.

FIG. 27 illustrates contents of the processing service group ID 126 for the existing systems after the scale-out according to the first embodiment of this invention.

The configuration of the processing service group ID 126 illustrated in FIG. 27 is the same as that of the processing service group ID 126 illustrated in FIG. 27. Moreover, data stored in the processing service group ID 126 illustrated in FIG. 27 is as described in the processing in S1411 of FIG. 17B.

FIG. 28 illustrates contents of the processing service group ID 126 for the added systems after the scale-out according to the first embodiment of this invention.

The configuration of the processing service group ID 126 illustrated in FIG. 28 is the same as that of the processing service group ID 126 illustrated in FIG. 11. Moreover, data stored in the processing service group ID 126 illustrated in FIG. 28 is as described in the processing in S1411 of FIG. 17B.

According to the first embodiment of this invention, by separating a server 110 for processing the services while held data is taken over by the server 110, the load can be distributed.

Moreover, according to the first embodiment of this invention, by limiting the quantity of data to be copied at the time of taking over the data to thereby restrain the load imposed upon servers 110 from increasing, services requested by clients 101 can be processed while the real time property is maintained.

Further, according to the first embodiment of this invention, because a request for processing a service is transmitted from a client 101 via multicast, even when servers 110 are reorganized, without reorganizing settings of the client 101, the request for processing the service can be maintained.

### Second Embodiment

While, according the first embodiment of this invention, a load is distributed by distributing services to be carried out on a server 110 having the load quantity exceeding a predetermined upper limit to other servers 110, according to the second embodiment of this invention, by merging servers 110 having small loads, computer resources are efficiently utilized. The merge of the servers 110 in this way is referred to as scale-in.

It should be noted that, in the second embodiment, a description of parts and components common to the first embodiment is properly omitted.

The system configuration of the second embodiment is the same as that of the first embodiment illustrated in FIGS. 1 and 2. Moreover, the configurations of the tables and the messages are the same as those of the first embodiment illustrated in FIGS. 4 to 12.

A description is now given of processing steps according to the second embodiment. Steps of carrying out a service by the server 110 based on a processing request transmitted from a client 101 are the same as the steps illustrated in FIGS. 14A and 14B according to the first embodiment.

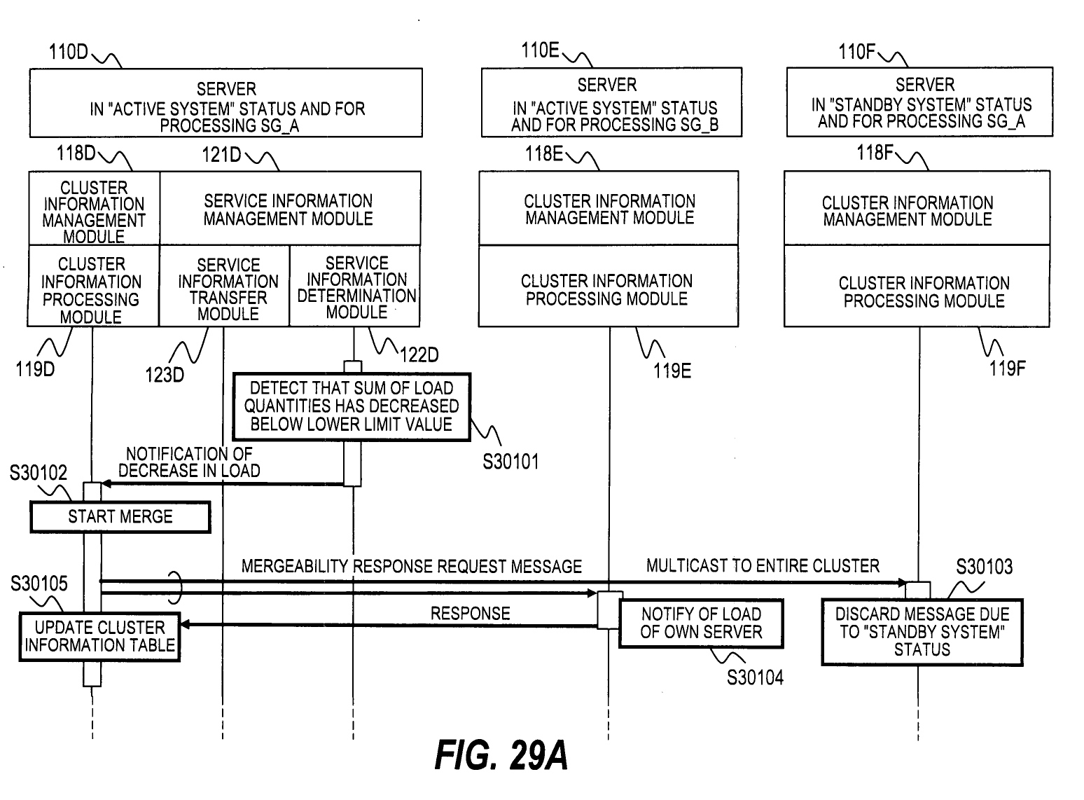

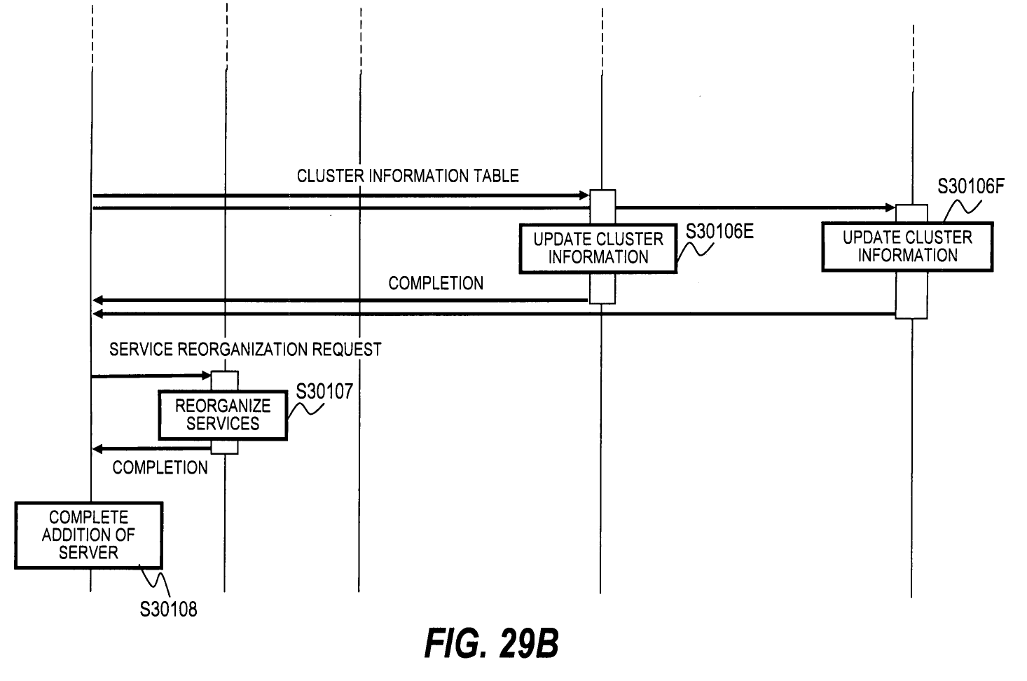

On this occasion, before the description is given of the processing steps, a description is given of a configuration of a computer system according to the second embodiment, and, in the computer system, a server 110D in the status of “ACTIVE SYSTEM” and a server 110F in the status of “STANDBY SYSTEM” are included in the same cluster and process a service group SG_A. Moreover, a server 110E in the status of “ACTIVE SYSTEM” which receives the multicast communication at the same multicast address is included the computer system, and processes a service group SG_B. A description is now given of steps of, when the load imposed on the server 110D decreases, migrating a processing subject of the service group SG_A to the server 110E with reference to FIGS. 29A and 29B.

FIGS. 29A and 29B describe steps of preparation processing for the scale-in according to the second embodiment of this invention.

A service information determination module 122D of the server 110D in the status of “ACTIVE SYSTEM”, upon detecting that the load imposed on the server 110D has exceeded the predetermined threshold (lower limit), notifies a cluster information processing module 119D of the excessive load (S30101). Specifically, the service information determination module 122D calculates the load quantity based on the CPU usage, the memory usage, an input/output processing quantity, and the like included in a system log of the server 110D and the like, and compares the load quantity with the threshold (lower limit in this case) set to the load quantity threshold table 127.

The cluster information processing module 119D, upon receiving, from the service information determination module 122D, a notification that the load quantity has fallen below the lower limit, transmits a mergeability response request message via multicast (S30102). The mergeability response request message has the same configuration as the added server response request message 1000 of FIG. 12, and the message type 1001 is “MERGEABILITY RESPONSE REQUEST”, and, in the message content 1002, the address of the own server (server 110D) is stored.

The server 110F is in the status of “STANDBY SYSTEM”, and is to process the service group SG_A. Thus, the processing service group ID 126 of the server 110F includes the service group SG_A.

A cluster information processing module 119F included in the cluster information management module 118F of the server 110F receives the mergeability response request message transmitted from the server 110D via multicast (S30103). The own server is in the status of “STANDBY SYSTEM”, and hence the cluster information processing module 119F discards the mergeability response request message.

Moreover, the server 110E receives the same multicast message, and is responsible for processing the service group SG_B. The processing service group ID 126 of the server 110E includes the service group SG_B, but does not include the service group SG_A.

When the cluster information processing module 119E of the server 110E receives the mergeability response request message transmitted via multicast from the server 110D, the own server 110 is in the status of “ACTIVE SERVER”, and hence the cluster information processing module 119E transmits a response to the server 110D which has transmitted the mergeability response request message (S30104). This response has the same configuration as the added server response request message 1000 of FIG. 12, and the message type 1001 is set to “MERGEABLE STATUS RESPONSE”, and, in the message content 1002, the load sum of all the services of the own server 110 and the cluster information table 120E are stored. The cluster information table 120E to be stored is illustrated in FIG. 31.

FIG. 31 illustrates contents of the cluster information table 120 of the server 110E which is the destination of the merge according to the second embodiment of this invention. The configuration of the cluster information table 120 illustrated in FIG. 31 is the same as that of the cluster information table 120 according to the first embodiment illustrated in FIG. 8.

The server 110D receives the response transmitted by the server 110E. When the server 110D receives the same response from a plurality of servers 110, the server 110D selects a server 110 which has the smallest load sum stored in the response. On this occasion, it is assumed that the server 110D selects the response of the server 110E, and a description is given of subsequent steps.

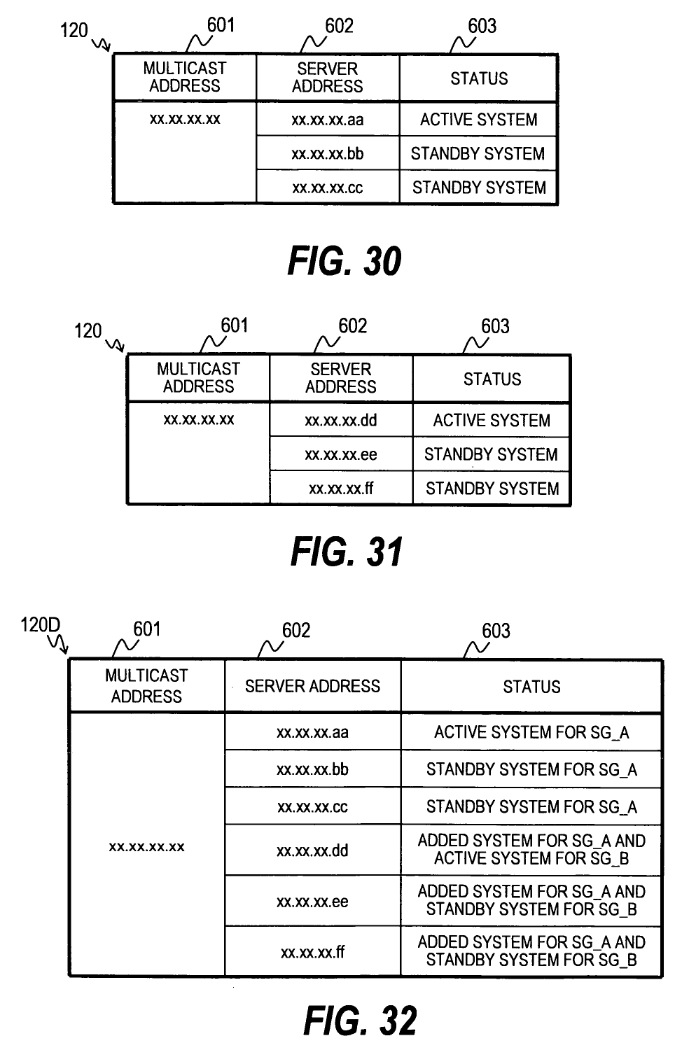

The server 110D, based on the cluster information table 120E included in the response, updates the cluster information table 120D of the server 110D, and transmits the updated cluster information table 120D to the multicast address (S30105). Specifically, to the cluster information table 120D, all server addresses 602 and statuses 603 included in the cluster information table 120E are added. Moreover, the status of the added server 110E is updated to “ADDED SYSTEM FOR SG_A AND ACTIVE SYSTEM FOR SG_B”, and the status of the other added servers 110 is updated to “ADDED SYSTEM FOR SG_A AND STANDBY SYSTEM FOR SG_B”. The cluster information table 120D before the update is illustrated in FIG. 30, and the cluster information table 120E after the update is illustrated in FIG. 32

FIG. 30 illustrates contents of the cluster information table 120D of the server 110D which is to be merged according to the second embodiment of this invention. The configuration of the cluster information table 120 illustrated in FIG. 30 is the same as that of the cluster information table 120 according to the first embodiment illustrated in FIG. 8.

FIG. 32 illustrates contents of the cluster information table 120E of the server 110E which is to be merged according to the second embodiment of this invention. The configuration of the cluster information table 120 illustrated in FIG. 32 is the same as that of the cluster information table 120 according to the first embodiment illustrated in FIG. 8.

The status of “ADDED SYSTEM FOR SG_A AND ACTIVE SYSTEM FOR SG_B” implies that the subject of processing the service group SG_A is shifting to this server, and that this server is the subject of processing the service group SG_B, for which the status of this server is “ACTIVE SYSTEM”. Moreover, the status of “ADDED SYSTEM FOR SG_A AND STANDBY SYSTEM FOR SG_B” implies that the subject of processing the service group SG_A is shifting to this server, and that this server 110 is the subject of processing the service group SG_B, for which the status of this server is “STANDBY SYSTEM”.

The cluster information processing module 119 of the server 110, which has received the updated cluster information table 120D, updates the cluster information table 120 of the own server 110 so that the contents are the same as contents of the received cluster information table 120D (S30106E, S30106F). After the update, the cluster information processing module 119 notifies the server 110D of the completion of the cluster information update.

After the server 110D has received the notification of the completion of the cluster information update from all the servers 110 to which the cluster information has been transmitted, the server 110D transmits a service reorganization request to the service information transfer module 123D.

The service information transfer module 123D receives the service reorganization request from the cluster information processing module 119D, and carries out the service reorganization processing (S30107). After the completion of the service reorganization processing, the service information transfer module 123D notifies the cluster information processing module 119D of the completion. On this occasion, in the service reorganization processing of S30107, based on the processing described referring to FIG. 16, the respective processing service group IDs 901 of the servers 110D, 110E, and 110F are changed to SG_A and SG_B.

The cluster information processing module 119D, upon receiving the notification that the service reorganization processing has been completed from the service information transfer module 123D, completes the merge preparation processing (S30108).

A description is now given of processing of actually merging service groups after the merge has been prepared. Though the merge processing has the same steps as those in FIGS. 17A and 17B, servers 110 constituting the cluster are different. In this case, in the same cluster, the server 110D in the status of “ACTIVE SYSTEM”, the server 110E in the status of “ADDED SYSTEM FOR SG_A AND ACTIVE SYSTEM FOR SG_B”, and the server 110F in the status of “STANDBY SYSTEM” are included, and, from the server 110D or 110F to the server 110E, processing data relating to the service group SG_A is transferred. Specifically, the differences in processing are as follows.

The cluster information management module 118D of the server 110D, in the processing in S1409, updates the cluster information table 120D as described below. The cluster information management module 118D refers to the statuses 603 of the cluster information table 120D, and creates a table including only the entry of “ADDED SYSTEM FOR SG_A AND ACTIVE SYSTEM FOR SG_B”, or “ADDED SYSTEM FOR SG_A AND STANDBY SYSTEM FOR SG_B”. Then, one of the servers 110 is set to the status of “ACTIVE SYSTEM”, and the other servers 110 are set to the status of “STANDBY SYSTEM”. For example, the server 110 in the status of “ADDED SYSTEM FOR SG_A AND ACTIVE SYSTEM FOR SG_B” is set to the status of “ACTIVE SYSTEM”, and the servers 110 in the status of “ADDED SYSTEM FOR SG_A AND STANDBY SYSTEM FOR SG_B” are set to the status of “STANDBY SYSTEM”. When the status 603 in the cluster information table 120D is “ADDED SYSTEM FOR SG_A AND ACTIVE SYSTEM FOR SG_B”, and a processing request for a service has been received from a client 101, only a service belonging to the service group SG_B is processed.

Moreover, the service information transfer module 123D carries out the service reorganization processing illustrated in FIG. 16, thereby notifying of the completion. On this occasion, in the service reorganization processing, the service information transfer module 123D sets the respective processing service group IDs 126 of the servers 110D and 110F to “NONE”, and changes the service information table 124 to a vacant matrix. Moreover, on the server 110E, the reorganization is carried out such that, in the processing service group ID 126, SG_A and SG_B are stored, and in the service information table 124, the services belonging to the service groups SG_A and SG_B are stored. As a result of the above-mentioned processing, the services belonging to the service group SG_A processed by the server 110D have been migrated to the server 110E.

According to the second embodiment of this invention, when a load imposed on servers 110 falls below a predetermined lower limit, by carrying out the scale-in to thereby remove the unnecessary servers 110, limited computer resources can be efficiently used.

Moreover, according to the second embodiment of this invention, a request for processing a service is transmitted from a client 101 via multicast, and hence, as in the first embodiment, even when servers 110 are reorganized, without reorganizing settings of the client 101, the request for processing the service can be maintained.

Moreover, by applying the second embodiment of this invention along with the first embodiment to a computer system, reorganization can be dynamically carried out according to loads on servers.

### Third Embodiment

According to a third embodiment of this invention, reliability levels are set in advance to respective services, and, based on the reliability levels, the number of servers to be increased/decreased is determined when a scale-out or scale-in is carried out.

It should be noted that, in the third embodiment, a description of parts and components common to the first and second embodiments is properly omitted.

The system organization of the third embodiment is the same as that of the first embodiment illustrated in FIGS. 1 and 2.

A description is now given of the third embodiment mainly emphasizing points different from the first embodiment.

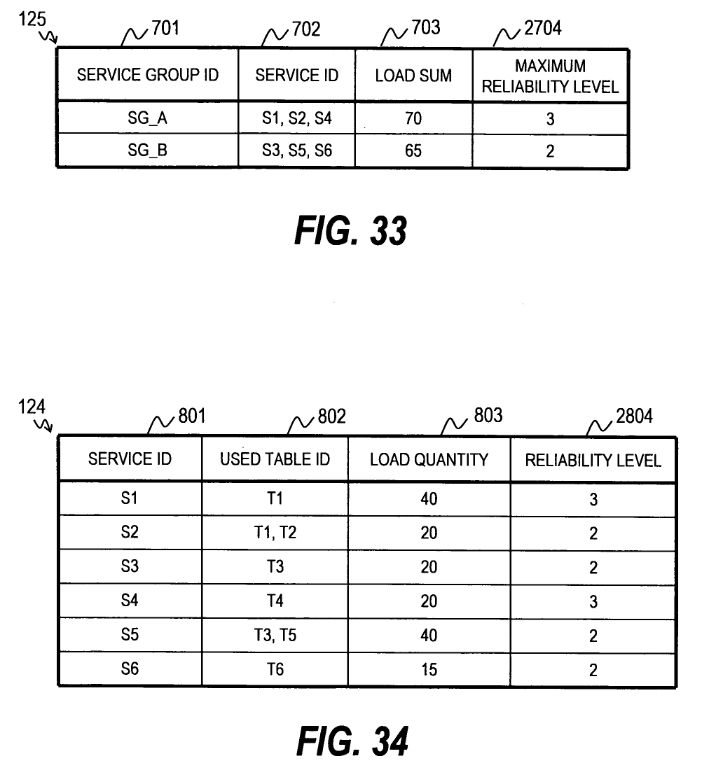

FIG. 33 illustrates an example of a configuration of the service group information table 125 according to the third embodiment of this invention.

The service group information table 125 includes, in addition to the configuration of the first embodiment, a maximum reliability level 2704.

The maximum reliability level 2704 stores the maximum value of reliability levels set to services belonging to a service group identified by the service group ID 701. In other words, the maximum value is the number of servers 110 necessary for the scale-out, which is set for each service group.

FIG. 34 illustrates an example of a configuration of the service information table 124 according to the third embodiment of this invention.

The service group information table 124 includes, in addition to the configuration of the first embodiment, a reliability level 2804. A service having the reliability level 2804 of “1” requires only one server 110 in the status of “ACTIVE SYSTEM”, a service having the reliability level 2804 of “2” requires one server 110 in the status of “ACTIVE SYSTEM” and one server 110 in the status of “STANDBY SYSTEM”, and a service having the reliability level 2804 of “3” requires one server 110 in the status of “ACTIVE SYSTEM” and two servers 110 in the status of “STANDBY SYSTEM”.

A description is now given of processing to be carried out for scaling out the system according to the reliability levels 2804 when a load imposed on a server 110 has exceeded the upper limit.

First, in the processing in S1201 of FIG. 15A, services are grouped so as to make the maximum reliability level 2704 of a resulting service group as small as possible. By making the maximum reliability level 2704, the number of servers 110 to be added can be reduced.

As an example of a method for making the maximum reliability level 2704 smaller, when the grouped services are distributed to a plurality of service group information tables 125 in the processing in S1802 of FIG. 20, and the load sums of the respective service groups are the same, the grouped services are respectively distributed to a service group having the maximum reliability level 2704 equal to or more than the maximum value of the reliability levels of the grouped services.

Further, while the number of servers 110 to be added in the processing in S1208 of FIG. 12 is set in advance according to the first embodiment, the number of the servers 110 to be added according to the third embodiment is the smallest value of the maximum reliability levels 2704 in the service group information table 125 created in the processing in S 1201. According to the third embodiment, in the service group information table 125 of FIG. 33, an entry having the service group ID 701 of SG_B has the smallest value “2” in the maximum reliability level 2704. Thus, the number of servers 110 to be added is two.

Subsequently, in the scale out processing, the system is scaled out such that services of the service group having the smallest maximum reliability level 2704 is processed by the added servers 110.

A description is now given of points different from the second embodiment.

When the data is transferred, to a response to a mergeability response request message, the largest value of the maximum reliability levels 2704 in the service group information table 125 of the own server 110 is added. The server 110D which is a source of the transmission of the mergeability response request message determines a destination of the merge, then compares the maximum reliability levels of the own server 110D and the server of the destination of the merge with each other, and sets the server 110 having the smaller value of the maximum reliability level 2704 as the source of transfer of the data. As a result of this processing, the services and the data are merged to the server 110 having the larger value of the maximum reliability level 2704.

According to the third embodiment of this invention, based on the reliability necessary for each service, the number of servers to be added or removed is determined, and hence it is possible to reorganize the computer system based on, in addition to the load status, the reliabilities of the services to be processed.

While the present invention has been described in detail and pictorially in the accompanying drawings, the present invention is not limited to such detail but covers various obvious modifications and equivalent arrangements, which fall within the purview of the appended claims.

What is claimed is:

1. A method of managing an organization of a computer system comprising a plurality of servers each capable of executing requested services,
the plurality of servers each comprising:
an interface for coupling with another one of the plurality of servers;
a processor coupled to the interface; and
a memory device for storing data necessary for providing the requested services,
the each of plurality of servers being assigned services that refer to the same data,
the method including the steps of:
selecting, by one of the plurality of servers, in a case where a load imposed on the one of the plurality of servers exceeds a predetermined upper limit, a server of transfer destination for executing some of the services to be executed on the one of the plurality of servers having the load imposed thereon exceeding the predetermined upper limit;
selecting, by the one of the plurality of servers, at least one service from the services assigned to the one of the plurality of servers having the load imposed thereon exceeding the predetermined upper limit;
assigning, by the one of the plurality of servers, the selected at least one service to the server of transfer destination; and
transferring, by the one of the plurality of servers, data necessary for executing the selected at least one service from the one of the plurality of servers having the load imposed thereon exceeding the predetermined upper limit to the server of transfer destination.

2. The method of managing an organization of a computer system according to claim 1, wherein:
a request for executing one of the services is transmitted to the plurality of servers by multicast communication; and
the method further includes the step of discarding, by the each of the plurality of servers that have received the request for executing the one of the services, the received request for executing the one of the services in a case where the requested services is not executed.

3. The method of managing an organization of a computer system according to claim 1, wherein:
the each of the plurality of servers is assigned a set of services for each service using the same data; and
the method further includes the steps of:
separating, by the each of the plurality of servers, the set of services into two sets;
selecting, by the each of the plurality of servers, one of the separated two sets; and
selecting, by the each of the plurality of servers, a service belonging to the selected one of the separated two sets.

4. The method of managing an organization of a computer system according to claim 1, wherein:
the plurality of servers comprise a first server for executing the service and a second server for, in a case where the first server fails, executing the service,
the method further includes the steps of:
transferring, by the first server, in a case where data stored in the first server is updated, differential information of the updated data to the second server; and
transferring, by one of the first server and the second server, the differential information to the server of transfer destination in a case where a load imposed on the first server has exceeded the predetermined upper limit, and thus, the first server transfers data stored in the first server to the server of transfer destination.

5. The method of managing an organization of a computer system according to claim 4, further including the steps of:
selecting, by the first server, from the plurality of servers, a plurality of servers of transfer destination;
selecting, by the first server, from the selected a plurality of servers of transfer destination, a third server for executing the service;
setting, by the first server, a server which is included in the selected a plurality of servers of transfer destination and is other than the selected third server, as a fourth server; and
transferring, by one of the first server and the second server, the differential information to the third server and the fourth server.

6. The method of managing an organization of a computer system according to claim 5, wherein:
the each of the services is set a reliability level indicating a reliability of the each of the services; and
the method further includes the step of determining, by the first server, a number of the plurality of servers of transfer destination to be selected based on the reliability level set to the selected at least one service.

7. The method of managing an organization of a computer system according to claim 4, wherein:
the differential information is transmitted to the plurality of servers by multicast communication; and
the method further includes the step of discarding, by the each of the plurality of servers that have received the differential information, the received differential information in a case where data to which the differential information is applied is not held.

8. The method of managing an organization of a computer system according to claim 1, further including the steps of:
selecting, by the one of the plurality of servers, in a case of the load imposed on one of the plurality of servers becomes equal to or less than a predetermined lower limit, a server of merge destination which is assigned with at least one service, and is not processing a service assigned to the one of the plurality of servers having the imposed load equal to or less than the predetermined lower limit;
assigning, by the one of the plurality of servers, all services assigned to the one of the plurality of servers having the imposed load equal to or less than the predetermined lower limit and all services assigned to the server of merge destination to one of the one of the plurality of servers having the imposed load equal to or less than the predetermined lower limit and the server of merge destination;
canceling, by the one of the plurality of servers, the assignment of the services with respect to another one of the one of the plurality of servers having the imposed load equal to or less than the predetermined lower limit and the server of merge destination, to which the services are not assigned; and
transferring, by the one of the plurality of servers, data stored in the another one of the one of the plurality of servers having the imposed load equal to or less than the predetermined lower limit and the server of merge destination, for which the assignment of the services is canceled, to the one of the one of the plurality of servers having the imposed load equal to or less than the predetermined lower limit and the server of merge destination, to which all the services are assigned.

9. The method of managing an organization of a computer system according to claim 8, wherein:
the each of the services is set a reliability level indicating a reliability of the each of the services; and the server assigns all the services to one of the one of the plurality of servers having the imposed load equal to or less than the predetermined lower limit and the server of merge destination, to which a service having a high reliability is assigned.

10. The method of managing an organization of a computer system according to claim 1, wherein the server selects, as the server of transfer destination, a server to which the service is not assigned.

11. The method of managing an organization of a computer system according to claim 1, further including the step of receiving, by the one of the plurality of servers, setting of the predetermined upper limit.

12. A computer system comprising a plurality of servers each capable of executing requested services, wherein:
the plurality of servers each comprise:
an interface for coupling with another one of the plurality of servers;
a processor coupled to the interface; and
a memory device for storing data necessary for providing the requested services;
each of the plurality of servers is assigned with services that refer to the same data; and
the each of the plurality of servers is configured to:
select, in a case where a load imposed on one of the plurality of servers exceeds a predetermined upper limit, a server of transfer destination for executing some of the services to be executed on the one of the plurality of servers having the load imposed thereon exceeding the predetermined upper limit;
select at least one service from the services assigned to the one of the plurality of servers having the load imposed thereon exceeding the predetermined upper limit;
assign the selected at least one service to the server of transfer destination; and
transfer data necessary for executing the selected at least one service from the one of the plurality of servers having the load imposed thereon exceeding the predetermined upper limit to the server of transfer destination.

13. A storage medium recorded with an organization management program executed by one of a plurality of servers included in a computer system and each capable of executing requested services,
each of the plurality of servers being assigned with services that refer to the same data,
the program including the steps of:
selecting, in a case where a load imposed on the one of the plurality of servers exceeds a predetermined upper limit, a server of transfer destination for executing some of the services to be executed on the one of the plurality of servers having the load imposed thereon exceeding the predetermined upper limit;
selecting at least one service from the services assigned to the one of the plurality of servers having the load imposed thereon exceeding the predetermined upper limit;
assigning the selected at least one service to the server of transfer destination; and
transferring data necessary for executing the selected at least one service from the one of the plurality of servers having the load imposed thereon exceeding the predetermined upper limit to the server of transfer destination.
